(19) United States
(12) Patent Application Publication
(10) Pub. No.: US 2025/0240661 A1
(43) Pub. Date: Jul. 24, 2025

(54) METHOD AND APPARATUS FOR UE-INITIATED BEAM REPORTING IN A WIRELESS COMMUNICATION SYSTEM

(71) Applicant: ASUS Technology Licensing Inc., Taipei City (TW)

(72) Inventors: Yi-Hsuan Kung, Taipei City (TW); Yu-Hsuan Guo, Taipei City (TW)

(21) Appl. No.: 19/032,384

(22) Filed: Jan. 20, 2025

Related U.S. Application Data
(60) Provisional application No. 63/624,132, filed on Jan. 23, 2024.

(51) Int. Cl. H04W 24/10; H04W 72/54

(52) U.S. Cl. CPC H04W 24/10; H04W 72/54

(57) ABSTRACT

Methods, systems, and apparatuses are provided for handling User Equipment (UE)-initiated beam reporting in a wireless communication system, wherein a method of a UE comprises triggering a UE-initiated beam reporting associated with multiple candidate cells, and determining, when an Uplink (UL) grant cannot accommodate all of one or more information associated with the multiple candidate cells for the UE-initiated beam reporting, whether to prioritize an information of a candidate cell of the multiple candidate cells to be transmitted via the UL grant based on at least a quality associated with the candidate cell.

### CROSS-REFERENCE TO RELATED APPLICATIONS

The present Application claims priority to and the benefit of U.S. Provisional Patent Application Ser. No. 63/624,132, filed Jan. 23, 2024, which is fully incorporated herein by reference.

### FIELD

This disclosure generally relates to wireless communication networks and, more particularly, to a method and apparatus for handling User Equipment (UE)-initiated beam reporting in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling User Equipment (UE)-initiated beam reporting in a wireless communication system.

In various embodiments, a method of a UE in a wireless communication system triggering a UE-initiated beam reporting associated with multiple candidate cells, and determining, when an Uplink (UL) grant cannot accommodate all of one or more information associated with the multiple candidate cells for the UE-initiated beam reporting, whether to prioritize an information of a candidate cell of the multiple candidate cells to be transmitted via the UL grant based on at least a quality associated with the candidate cell.

In various embodiments, a method of a UE in a wireless communication system comprises triggering a UE-initiated beam reporting associated with one or more candidate cells, and determining, when a UL grant cannot accommodate all of one or more information associated with the one or more candidate cells for the UE-initiated beam reporting, whether to prioritize an information of the one or more information to be transmitted via the UL grant based on at least a quality of a beam associated with the information.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 6.1.3.14-1: TCI States Activation/Deactivation for UE-specific PDSCH MAC CE, from 3GPP 38.321 v17.4.0.

FIG. 6 is a reproduction of FIG. 6.1.3.15-1: TCI State Indication for UE-specific PDCCH MAC CE, from 3GPP 38.321 v17.4.0.

FIG. 7 is a reproduction of FIG. 6.1.3.24-1: Enhanced TCI States Activation/Deactivation for UE-specific PDSCH MAC CE, from 3GPP 38.321 v17.4.0.

FIG. 8 is a reproduction of FIG. 6.1.3.23-1: BFR and Truncated BFR MAC CE with one octet Ci field, from 3GPP 38.321 v17.4.0.

FIG. 9 is a reproduction of FIG. 6.1.3.23-2: BFR and Truncated BFR MAC CE with four octets Ci field, from 3GPP 38.321 v17.4.0.

FIG. 10 is a reproduction of FIG. 6.1.3.43-1: Enhanced BFR and Truncated Enhanced BFR MAC CE with one octet Ci field, from 3GPP 38.321 v17.4.0.

FIG. 11 is a reproduction of FIG. 6.1.3.43-2: Enhanced BFR and Truncated Enhanced BFR MAC CE with four octets Ci field, from 3GPP 38.321 v17.4.0.

FIG. 12 is a reproduction of FIG. 6.1.3.44-1: Enhanced TCI States Indication for UE-specific PDCCH MAC CE, from 3GPP 38.321 v17.4.0.

FIG. 13 is a reproduction of FIG. 6.1.3.47-1: Unified TCI state activation/deactivation MAC CE, from 3GPP 38.321 v17.4.0.

FIG. 14 is a reproduction of FIG. 9.2.3.5.2-1. Signaling procedure for LTM, from Draft 38.300 v 18.0.0.

FIG. 15 is an example diagram showing an issue where a network could receive outdated beam information or the UE could transmit unnecessary beam reporting information when two procedures collide, in accordance with embodiments of the present invention.

FIG. 16 is an example diagram showing that a UE could cancel or stop a (triggered or ongoing) UE-initiated beam reporting of a first Serving Cell in response to initiation of an LTM procedure, or in response to receiving an LTM cell switch command MAC CE from a network, in accordance with embodiments of the present invention.

FIG. 17 is an example diagram showing that a UE may not trigger a UE-initiated beam reporting of a first Serving Cell in response to an ongoing LTM procedure, or in response to receiving an LTM cell switch command MAC CE from a network, in accordance with embodiments of the present invention.

FIG. 18 is an example diagram showing that when or if (at least) there is an ongoing first one or more procedures (e.g., BFR, beam change procedure, MAC reset, or Handover or an LTM procedure) the UE may not trigger or initiate or perform a UE-initiated beam reporting for L1 measurement report for LTM or for a candidate cell, in accordance with embodiments of the present invention.

FIG. 19 is an example diagram showing an example of a UE-initiated beam report, in accordance with embodiments of the present invention.

FIG. 20 is an example diagram showing an example of a UE-initiated beam report including a Cell index (e.g., serving cell index or candidate cell index) or an id (e.g., a physical cell id), a cell type (e.g., Serving Cell, candidate cell, or neighboring cell), a BWP id associated with reported beam(s), and beam information associated with the one Cell (only), in accordance with embodiments of the present invention.

FIG. 21 is an example diagram showing the process of determining information to report in a (truncated) UE-initiated beam report, in accordance with embodiments of the present invention.

FIG. 22 is a flow diagram of a method of a UE in a wireless communication system comprising in response to a condition of a UE-initiated beam reporting being met, determining whether to trigger a UE-initiated beam reporting based on at least whether there is an ongoing first procedure, in accordance with embodiments of the present invention.

FIG. 23 is a flow diagram of a method of a UE in a wireless communication system comprising triggering a UE-initiated beam reporting of a Cell in response to a condition of a UE-initiated beam reporting being met, and canceling the UE-initiated beam reporting of the Cell in response to initiation or reception of a first procedure associated with the Cell, in accordance with embodiments of the present invention.

FIG. 24 is a flow diagram of a method of a UE in a wireless communication system comprising triggering a UE-initiated beam reporting of a Cell in response to a condition of a UE-initiated beam reporting being met, and assembling and transmitting a UE-initiated beam report to a network in response to the triggered UE-initiated beam reporting, in accordance with embodiments of the present invention.

FIG. 25 is a flow diagram of a method of a UE in a wireless communication system comprising triggering a UE-initiated beam reporting associated with multiple candidate cells, and determining, when a UL grant cannot accommodate all of one or more information associated with the multiple candidate cells for the UE-initiated beam reporting, whether to prioritize an information of a candidate cell of the multiple candidate cells to be transmitted via the UL grant based on at least a quality associated with the candidate cell, in accordance with embodiments of the present invention.

FIG. 26 is a flow diagram of a method of a UE in a wireless communication system comprising triggering a UE-initiated beam reporting associated with one or more candidate cells, and determining, when a UL grant cannot accommodate all of one or more information associated with the one or more candidate cells for the UE-initiated beam reporting, whether to prioritize an information of the one or more information to be transmitted via the UL grant based on at least a quality of a beam associated with the information, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-234007 New WID: NR MIMO Phase 5; [2] 3GPP 38.214 v17.4.0; [3] 3GPP 38.321 v17.4.0; [4] 3GPP 38.331 v17.4.0; [5] Draft 38.300 v 18.0.0; and [6] RP-234036 New WID: NR mobility enhancements Phase 4. The standards and documents listed above are hereby expressly and fully incorporated herein by reference in their entirety.

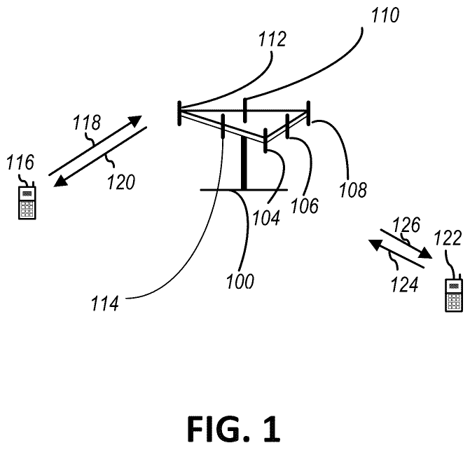

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

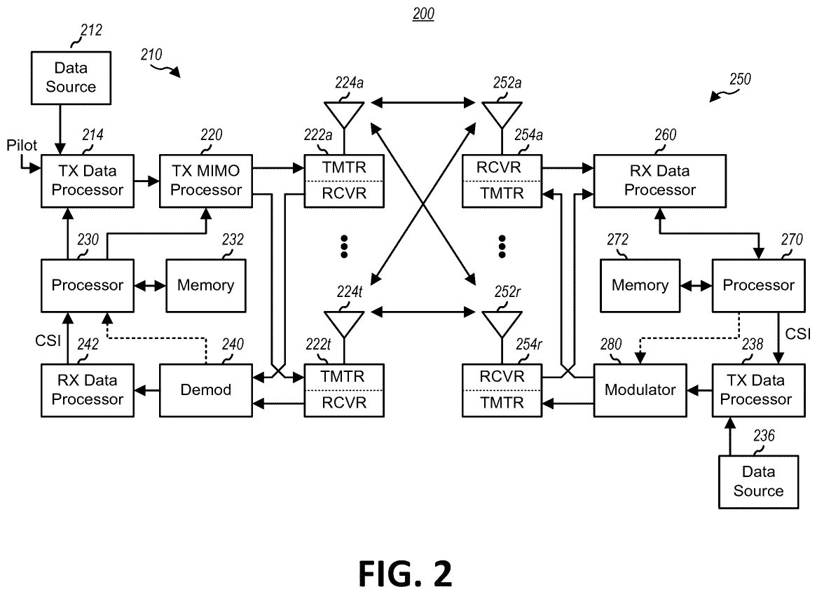

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

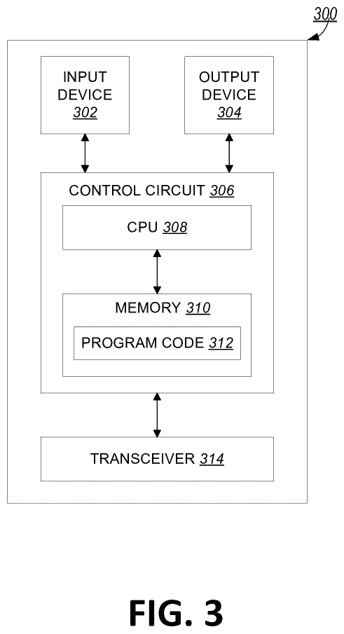

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

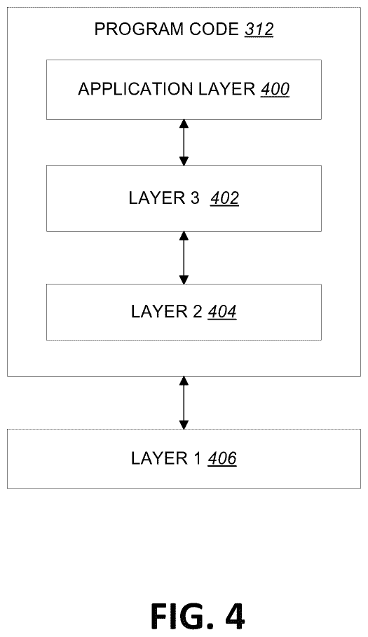

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In Work item description RP-234007 ([1] RP-234007 New WID: NR MIMO Phase 5), MIMO enhancement for Rel-19 is introduced:

### 3 Justification

In legacy beam management procedures, the network may configure/activate frequent periodic or semi-persistent beam reporting (e.g., N best beams and corresponding L1-RSRPs) or triggers frequent aperiodic beam reporting to timely acquire the best/preferred beam for data/control transmissions. However, this clearly results in large UL reporting overhead and control signaling overhead. At the same time, if less frequent beam reporting is configured, the network could not always acquire ‘best/preferred’ beam(s) as the beam reporting by the UE may be outdated, thus leading to performance degradation. Given that UE has better and more-timely knowledge of beam quality changes, UE-initiated beam reporting procedure can lead to more timely beam reports yet with reduced reporting overhead. Under such a procedure, if the UE determines that e.g., current beam(s) quality becomes poor, UE can trigger beam reporting without the network needing to configure or trigger frequent reporting.

### 4 Objective

### 4.1 Objective of SI or Core Part WI or Testing Part WI

The detailed objectives are as follows:

### RAN1:

1. Specify enhancement to facilitate UE-initiated/event-driven beam management for reducing overhead and/or latency, assuming the unified TCI while leveraging (as much as possible) legacy CSI measurement and reporting configuration frameworks, targeting FR2 and sTRP with intra- and inter-cell beam management
   a. UL signaling content(s) (and procedure(s) as required) for UE-initiated/event-driven beam reporting facilitating fast beam switching
   b. UL signaling medium/container considering the UE-initiated/event-driven nature of the UL transmission, designed primarily for the purpose of beam reporting
. . .
In [2] 3GPP 38.214 v17.4.0, CSI reporting is introduced:

### 5.2 UE Procedure for Reporting Channel State Information (CSI)

### 5.2.1 Channel State Information Framework

The procedures on aperiodic CSI reporting described in this clause assume that the CSI reporting is triggered by DCI format 0_1, but they equally apply to CSI reporting triggered by DCI format 0_2, by applying the higher layer parameter reportTriggerSizeDCI-0-2 instead of reportTriggerSize.

The time and frequency resources that can be used by the UE to report CSI are controlled by the gNB. CSI may consist of Channel Quality Indicator (CQI), precoding matrix indicator (PMI), CSI-RS resource indicator (CRI), SS/PBCH Block Resource indicator (SSBRI), layer indicator (LI), rank indicator (RI), L1-RSRP, L1-SINR or CapabilityIndex.

For CQI, PMI, CRI, SSBRI, LI, RI, L1-RSRP, L1-SINR, Capability [Set] Index a UE is configured by higher layers with N>1 CSI-ReportConfig Reporting Settings, M≥1 CSI-ResourceConfig Resource Settings, and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList contains a list of associated CSI-ReportConfigs indicating the Resource Set IDs for channel and optionally for interference. Each trigger state in CSI-SemiPersistentOnPUSCH-TriggerStateList contains one associated CSI-ReportConfig.

### 5.2.1.1 Reporting Settings

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE such as the layer indicator (LI), L1-RSRP, L1-SINR, CRI, and SSBRI (SSB Resource Indicator) and CapabilityIndex.

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related, L1-SINR-related or CapabilityIndex-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements and timeRestrictionForInterferenceMeasurements can be configured to enable time domain restriction for interference measurements. The CSI-ReportConfig can also contain CodebookConfig, which contains configuration parameters for Type-I, Type II, Enhanced Type II CSI, or Further Enhanced Type II Port Selection including codebook subset restriction when applicable, and configurations of group-based reporting. A UE is not expected to be configured with a CSI report setting associated with a dormant DL BWP if the reportConfigType is set to ‘aperiodic’.

### 5.2.1.2 Resource Settings

Each CSI Resource Setting CSI-ResourceConfig contains a configuration of a list of S≥1 CSI Resource Sets (given by higher layer parameter csi-RS-ResourceSetList), where the list is comprised of references to either or both of NZP CSI-RS resource set(s) and SS/PBCH block set(s) or the list is comprised of references to CSI-IM resource set(s). Each CSI Resource Setting is located in the DL BWP identified by the higher layer parameter BWP-id, and all CSI Resource Settings linked to a CSI Report Setting have the same DL BWP.

The time domain behavior of the CSI-RS resources within a CSI Resource Setting are indicated by the higher layer parameter resourceType and can be set to aperiodic, periodic, or semi-persistent. For periodic and semi-persistent CSI Resource Settings, when the UE is configured with groupBasedBeamReporting-r17, the number of CSI Resource Sets configured is S=2, otherwise the number of CSI-RS Resource Sets configured is limited to S=1. For periodic and semi-persistent CSI Resource Settings, the configured periodicity and slot offset is given in the numerology of its associated DL BWP, as given by BWP-id. When a UE is configured with multiple CSI-ResourceConfigs consisting the same NZP CSI-RS resource ID, the same time domain behavior shall be configured for the CSI-ResourceConfigs. When a UE is configured with multiple CSI-ResourceConfigs consisting the same CSI-IM resource ID, the same time-domain behavior shall be configured for the CSI-ResourceConfigs. All CSI Resource Settings linked to a CSI Report Setting shall have the same time domain behavior.

The following are configured via higher layer signaling for one or more CSI Resource Settings for channel and interference measurement:
CSI-IM resource for interference measurement as described in Clause 5.2.2.4.
NZP CSI-RS resource for interference measurement as described in Clause 5.2.2.3.1.
NZP CSI-RS resource for channel measurement as described in Clause 5.2.2.3.1.

The UE may assume that the NZP CSI-RS resource(s) for channel measurement and the CSI-IM resource(s) for interference measurement configured for one CSI reporting are resource-wise QCLed with respect to ‘typeD’. When NZP CSI-RS resource(s) is used for interference measurement, the UE may assume that the NZP CSI-RS resource for channel measurement and the CSI-IM resource or NZP CSI-RS resource(s) for interference measurement configured for one CSI reporting are QCLed with respect to ‘typeD’.

### 5.2.1.4 Reporting Configurations

The UE shall calculate CSI parameters (if reported) assuming the following dependencies between CSI parameters (if reported)
LI shall be calculated conditioned on the reported CQI, PMI, RI and CRI
CQI shall be calculated conditioned on the reported PMI, RI and CRI
PMI shall be calculated conditioned on the reported RI and CRI
RI shall be calculated conditioned on the reported CRI.

The Reporting configuration for CSI can be aperiodic (using PUSCH), periodic (using PUCCH) or semi-persistent (using PUCCH, and DCI activated PUSCH). The CSI-RS Resources can be periodic, semi-persistent, or aperiodic. Table 5.2.1.4-1 shows the supported combinations of CSI Reporting configurations and CSI-RS Resource configurations and how the CSI Reporting is triggered for each CSI-RS Resource configuration. Periodic CSI-RS is configured by higher layers. Semi-persistent CSI-RS is activated and deactivated as described in Clause 5.2.1.5.2. Aperiodic CSI-RS is configured and triggered/activated as described in Clause 5.2.1.5.1.

TABLE 5.2.1.4-1
Triggering/Activation of CSI Reporting for the possible CSI-RS Configurations.

| | Periodic CSI | Semi-Persistent CSI | Aperiodic CSI |
|---|---|---|---|
| CSI-RS Configuration | Reporting | Reporting | Reporting |
| Periodic CSI-RS | No dynamic | For reporting on PUCCH, | Triggered by DCI; |
| | triggering/activation | the UE receives an | additionally, subselection |
| | | activation command, as | indication as described in |
| | | described in clause | clause 6.1.3.13 of [10, TS |
| | | 6.1.3.16 of [10, TS 38.321]; | 38.321] possible as defined |
| | | for reporting on PUSCH, | in Clause 5.2.1.5.1. |
| | | the UE receives triggering | |
| | | on DCI | |
| Semi-Persistent CSI-RS | Not Supported | For reporting on PUCCH, | Triggered by DCI; |
| | | the UE receives an | additionally, subselection |
| | | activation command, as | indication as described in |
| | | described in clause | clause 6.1.3.13 of [10, TS |
| | | 6.1.3.16 of [10, TS 38.321]; | 38.321] possible as defined |
| | | for reporting on PUSCH, | in Clause 5.2.1.5.1. |
| | | the UE receives triggering | |
| | | on DCI | |
| Aperiodic CSI-RS | Not Supported | Not Supported | Triggered by DCI; |
| | | | additionally, subselection |
| | | | indication as described in |
| | | | clause 6.1.3.13 of [10, TS |
| | | | 38.321] possible as defined |
| | | | in Clause 5.2.1.5.1. |

When the UE is configured with higher layer parameter NZP-CSI-RS-ResourceSet and when the higher layer parameter repetition is set to ‘off’, the UE shall determine a CRI from the supported set of CRI values as defined in Clause 6.3.1.1.2 of [5, TS 38.212] and report the number in each CRI report. When the higher layer parameter repetition for a CSI-RS Resource Set for channel measurement is set to ‘on’, CRI for the CSI-RS Resource Set for channel measurement is not reported. CRI reporting is not supported when the higher layer parameter codebookType is set to ‘typeII’, ‘typeII-PortSelection’, ‘typeII-r16’, to ‘typeII-PortSelection-r16’, or ‘typeII-PortSelection-r17’.

For a periodic or semi-persistent CSI report on PUCCH, the periodicity Test (measured in slots) and the slot offset T_{offset} are configured by the higher layer parameter reportSlotConfig. Unless specified otherwise, the UE shall transmit the CSI report in frames with SFN n_{f} and slot number within the frame n_{s,f}^{μ} satisfying

$$( {N}_{slot}^{frame , μ} {n}_{f} + {n}_{s , f}^{μ} - {T}_{offset} ) mod {T}_{CSI} = 0$$

where μ is the SCS configuration of the UL BWP the CSI report is transmitted on.

For a semi-persistent CSI report on PUSCH, the periodicity T_{CSI} (measured in slots) is configured by the higher layer parameter reportSlotConfig. Unless specified otherwise, the UE shall transmit the CSI report in frames with SFN n_{f} and slot number within the frame n_{s,f}^{μ} satisfying

$$( {N}_{slot}^{frame , μ} ( {n}_{f} - {n}_{f}^{start} ) + {n}_{s , f}^{μ} - {n}_{s , f}^{start} ) mod {T}_{CSI} = 0$$

where n_{f}^{start} and n_{s,f}^{start} are the SFN and slot number within the frame respectively of the initial semi-persistent PUSCH transmission according to the activating DCI.

For a semi-persistent or aperiodic CSI report on PUSCH, the allowed slot offsets are configured by the following higher layer parameters:
if triggered/activated by DCI format 0_2 and the higher layer parameter reportSlotOffsetListDCI-0-2 is configured, the allowed slot offsets are configured by reportSlotOffsetListDCI-0-2, and
if triggered/activated by DCI format 0_1 and the higher layer parameter reportSlotOffsetListDCI-0-1 is configured, the allowed slot offsets are configured by reportSlotOffsetListDCI-0-1, and
otherwise, the allowed slot offsets are configured by the higher layer parameter reportSlotOffsetList.

The offset is selected in the activating/triggering DCI.
. . .

### 5.2.1.4.2 Report Quantity Configurations

A UE may be configured with a CSI-ReportConfig with the higher layer parameter reportQuantity set to either ‘none’, ‘cri-RI-PMI-CQI’, ‘cri-RI-i1’, ‘cri-RI-i1-CQI’, ‘cri-RI-CQI’, ‘cri-RSRP’, ‘cri-SINR’, ‘ssb-Index-RSRP’, ‘ssb-Index-SINR’, ‘cri-RI-LI-PMI-CQI’, ‘cri-RSRP-Index’, ‘ssb-Index-RSRP-Index’, ‘cri-SINR-Index’ or ‘ssb-Index-SINR-Index’.

If the UE is configured with a CSI-ReportConfig with the higher layer parameter reportQuantity set to ‘none’, then the UE shall not report any quantity for the CSI-ReportConfig.

If the UE is configured with a CSI-ReportConfig with the higher layer parameter reportQuantity set to ‘cri-RI-PMI-CQI’, or ‘cri-RI-LI-PMI-CQI’, the UE shall report a preferred precoder matrix for the entire reporting band, or a preferred precoder matrix per subband, according to Clause 5.2.2.2.

If the UE is configured with a CSI-ReportConfig with the higher layer parameter reportQuantity set to ‘cri-RI-i1’,
the UE expects, for that CSI-ReportConfig, to be configured with higher layer parameter codebookType set to ‘typeI-SinglePane1’ and pmi-FormatIndicator set to ‘widebandPMI’ and,
the UE shall report a PMI consisting of a single wideband indication (i₁ in Clause 5.2.2.2.1) for the entire CSI reporting band.
. . .

If the UE is configured with a CSI-ReportConfig with the higher layer parameter reportQuantity set to ‘cri-RSRP’, ‘ssb-Index-RSRP’, ‘cri-RSRP-Index’ or ‘ssb-Index-RSRP-Index’,
if the UE is configured with the higher layer parameter groupBasedBeamReporting set to ‘disabled’, the UE is not required to update measurements for more than 64 CSI-RS and/or SSB resources, and the UE shall report in a single report nrofReportedRS (higher layer configured) different CRI or SSBRI for each report setting.
if the UE is configured with the higher layer parameter groupBasedBeamReporting set to ‘enabled’, the UE is not required to update measurements for more than 64 CSI-RS and/or SSB resources, and the UE shall report in a single reporting instance two different CRI or SSBRI for each report setting, where CSI-RS and/or SSB resources can be received simultaneously by the UE either with a single spatial domain receive filter, or with multiple simultaneous spatial domain receive filters.
if the UE is configured with the higher layer parameter groupBasedBeamReporting-r17, the UE is not required to update measurements for more than 64 CSI-RS and/or SSB resources, and the UE shall report in a single reporting instance nrofReportedGroups, if configured, group(s) of two CRIs or SSBRIs selecting one CSI-RS or SSB from each of the two CSI Resource Sets for the report setting, where CSI-RS and/or SSB resources of each group can be received simultaneously by the UE.

If the UE is configured with a CSI-ReportConfig with the higher layer parameter reportQuantity set to ‘cri-SINR’, ‘ssb-Index-SINR’, ‘cri-SINR-Index’ or ‘ssb-Index-SINR-Index’,
if the UE is configured with the higher layer parameter groupBasedBeamReporting set to ‘disabled’, the UE shall report in a single report nrofReportedRS (higher layer configured) different CRI or SSBRI for each report setting.
if the UE is configured with the higher layer parameter groupBasedBeamReporting set to ‘enabled’, the UE shall report in a single reporting instance two different CRI or SSBRI for each report setting, where CSI-RS and/or SSB resources can be received simultaneously by the UE.

If the UE is configured with a CSI-ReportConfig with the higher layer parameter reportQuantity set to ‘cri-RSRP’, ‘cri-RI-PMI-CQI’, ‘cri-RI-i1’, ‘cri-RI-i1-CQI’, ‘cri-RI-CQI’, ‘cri-RI-LI-PMI-CQI’, ‘cri-SINR’, or ‘cri-SINR-Index’, and Kₛ>1 resources are configured in the corresponding resource set for channel measurement, then the UE shall derive the CSI parameters other than CRI conditioned on the reported CRI, where CRI k (k≥0) corresponds to the configured (k+1)-th entry of associated nzp-CSI-RS-Resources in the corresponding NZP-CSI-RS-ResourceSet for channel measurement, and (k+1)-th entry of associated csi-IM-Resource in the corresponding csi-IM-ResourceSet (if configured) or (k+1)-th entry of associated nzp-CSI-RS-Resources in the corresponding NZP-CSI-RS-ResourceSet (if configured for CSI-ReportConfig with reportQuantity set to ‘cri-SINR’ or ‘cri-SINR-Index’) for interference measurement. If Kₛ=2 CSI-RS resources are configured, each resource shall contain at most 16 CSI-RS ports. If 2<Kₛ≤8 CSI-RS resources are configured, each resource shall contain at most 8 CSI-RS ports.
. . .

If the UE is configured with a CSI-ReportConfig with the higher layer parameter reportQuantity set to ‘ssb-Index-RSRP’ or ‘ssb-Index-RSRP-Index’, the UE shall report SSBRI, where SSBRI k (k≥0) corresponds to the configured (k+1)-th entry of the associated csi-SSB-ResourceList in the corresponding CSI-SSB-ResourceSet.

If the UE is configured with a CSI-ReportConfig with the higher layer parameter reportQuantity set to ‘ssb-Index-SINR’ or ‘ssb-Index-SINR-Index’, the UE shall derive L1-SINR conditioned on the reported SSBRI, where SSBRI k (k≥0) corresponds to the configured (k+1)-th entry of the associated csi-SSB-ResourceList in the corresponding CSI-SSB-ResourceSet for channel measurement, and (k+1)-th entry of associated csi-IM-Resource in the corresponding csi-IM-ResourceSet (if configured) or (k+1)-th entry of associated nzp-CSI-RS-Resources in the corresponding NZP-CSI-RS-ResourceSet (if configured) for interference measurement.

. . .

### 5.2.1.4.3 L1-RSRP Reporting

For L1-RSRP computation
the UE may be configured with CSI-RS resources, SS/PBCH Block resources or both CSI-RS and SS/PBCH block resources, when resource-wise quasi co-located with ‘type C’ and ‘typeD’ when applicable.
the UE may be configured with CSI-RS resource setting up to 16 CSI-RS resource sets having up to 64 resources within each set. The total number of different CSI-RS resources over all resource sets is no more than 128.

For L1-RSRP reporting, if the higher layer parameter nrofReportedRS in CSI-ReportConfig is configured to be one, the reported L1-RSRP value is defined by a 7-bit value in the range [−140,−44] dBm with 1 dB step size, if the higher layer parameter nrofReportedRS is configured to be larger than one, or if the higher layer parameter groupBasedBeamReporting is configured as ‘enabled’, or if the higher layer parameter groupBasedBeamReporting-r17 is configured, the UE shall use differential L1-RSRP based reporting, where the largest measured value of L1-RSRP is quantized to a 7-bit value in the range [−140,−44] dBm with 1 dB step size, and the differential L1-RSRP is quantized to a 4-bit value. The differential L1-RSRP value is computed with 2 dB step size with a reference to the largest measured L1-RSRP value which is part of the same L1-RSRP reporting instance. The mapping between the reported L1-RSRP value and the measured quantity is described in [11, TS 38.133].

When the higher layer parameter groupBasedBeamReporting-r17 in CSI-ReportConfig is configured, the UE shall indicate the CSI Resource Set associated with the largest measured value of L1-RSRP, and for each group, CRI or SSBRI of the indicated CSI Resource Set is present first.

If the higher layer parameter timeRestrictionForChannelMeasurements in CSI-ReportConfig is set to “notConfigured”, the UE shall derive the channel measurements for computing L1-RSRP value reported in uplink slot n based on only the SS/PBCH or NZP CSI-RS, no later than the CSI reference resource, (defined in TS 38.211 [4]) associated with the CSI resource setting.

If the higher layer parameter timeRestrictionForChannelMeasurements in CSI-ReportConfig is set to “Configured”, the UE shall derive the channel measurements for computing L1-RSRP reported in uplink slot n based on only the most recent, no later than the CSI reference resource, occasion of SS/PBCH or NZP CSI-RS (defined in [4, TS 38.211]) associated with the CSI resource setting.

When the UE is configured with SSB-MTC-AddtionalPCI, a CSI-SSB-ResourceSet configured for L1-RSRP reporting includes one set of SSB indices and one set of PCI indices, where each SSB index is associated with a PCI index.

When the UE is configured with a CSI-ReportConfig with the higher layer parameter reportQuantity set to ‘cri-RSRP-Index’ or ‘ssb-Index-RSRP-Index’ an index of UE capability value set, indicating the maximum supported number of SRS antenna ports, is reported along with the pair of SSBRI/CRI and L1-RSRP.

### 5.2.1.5 Triggering/Activation of CSI Reports and CSI-RS

5.2.1.5.1 Aperiodic CSI Reporting/Aperiodic CSI-RS when the Triggering PDCCH and the CSI-RS have the Same Numerology

For CSI-RS resource sets associated with Resource Settings configured with the higher layer parameter resourceType set to ‘aperiodic’, ‘periodic’, or ‘semi-persistent’, trigger states for Reporting Setting(s) (configured with the higher layer parameter reportConfigType set to ‘aperiodic’) and/or Resource Setting for channel and/or interference measurement on one or more component carriers are configured using the higher layer parameter CSI-AperiodicTriggerStateList. For aperiodic CSI report triggering, a single set of CSI triggering states are higher layer configured, wherein the CSI triggering states can be associated with any candidate DL BWP. A UE is not expected to receive more than one DCI with non-zero CSI request field per slot per cell. A UE is not expected to receive DCI with non-zero CSI request field within a cell group in a slot overlapping with any slot receiving DCI with non-zero CSI request field in the same cell group. A UE is not expected to be configured with different TCI-StateId's for the same aperiodic CSI-RS resource ID configured in multiple aperiodic CSI-RS resource sets with the same triggering offset in the same aperiodic trigger state. A UE is not expected to receive more than one aperiodic CSI report request for transmission in a given slot per cell. A UE is not expected to receive an aperiodic CSI report request for transmission in a slot overlapping with any slot having an aperiodic CSI report transmission in the same cell group. If a UE does not indicate its capability of CSItriggerStateContainingNonactiveBWP the UE is not expected to be triggered with a CSI report for a non-active DL BWP. Otherwise, when a UE is triggered with a CSI report for a DL BWP that is non-active when expecting to receive the most recent occasion, no later than the CSI reference resource, of the associated NZP CSI-RS, the UE is not expected to report the CSI for the non-active DL BWP and the CSI report associated with that BWP is omitted. When a UE is triggered with aperiodic NZP CSI-RS in a DL BWP that is non-active when expecting to receive the NZP CSI-RS, the UE is not expected to measure the aperiodic CSI-RS. In the carrier of the serving cell expecting to receive that associated NZP CSI-RS, if the active DL BWP when receiving the NZP CSI-RS is different from the active DL BWP when receiving the triggering DCI,
the last symbol of the PDCCH span of the DCI carrying the BWP switching shall be no later than the last symbol of the PDCCH span of the DCI carrying the CSI trigger, irrespective of whether they are in the same carrier of a serving cell or not and irrespective of whether they are in the same SCS or not;
the UE is not expected to have any other BWP switching in that carrier after the last symbol of the PDCCH span covering the DCI carrying the CSI trigger and before the first symbol of the triggered NZP CSI-RS or CSI-IM.
when the PDCCH reception includes two PDCCH candidates from two respective search space sets, as described in clause 10.1 of [6, TS 38.213], the span that involves the PDCCH candidate that ends later in time is used.

A trigger state is initiated using the CSI request field in DCI.
When all the bits of CSI request field in DCI are set to zero, no CSI is requested.
When the number of configured CSI triggering states in CSI-AperiodicTriggerStateList is greater than 2^{N}^{_{TS}}−1, where N_{TS} is the number of bits in the DCI CSI request field, the UE receives a subselection indication, as described in clause 6.1.3.13 of [10, TS 38.321], used to map up to 2^{N}^{_{TS}}−1 trigger states to the codepoints of the CSI request field in DCI. N_{TS} is configured by the higher layer parameter reportTriggerSize where N_{TS}∈{0, 1, 2, 3, 4, 5, 6}. When the UE would transmit a PUCCH with HARQ-ACK information in slot n corresponding to the PDSCH carrying the subselection indication, the corresponding action in [10, TS 38.321] and UE assumption on the mapping of the selected CSI trigger state(s) to the codepoint(s) of DCI CSI request field shall be applied starting from the first slot that is after slot

$$n + 3 {N}_{slot}^{subframe , μ} + \frac{{2}^{μ}}{{2}^{{μ}_{{K}_{mac}}}} \cdot {k}_{mac}$$

where μ is the SCS configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided.
When the number of CSI triggering states in CSI-AperiodicTriggerStateList is less than or equal to 2^{N}^{_{TS}}−1, the CSI request field in DCI directly indicates the triggering state.
For each aperiodic CSI-RS resource in a CSI-RS resource set associated with each CSI triggering state, the UE is indicated the quasi co-location configuration of quasi co-location RS source(s) and quasi co-location type(s), as described in clause 5.1.5, through higher layer signaling of qcl-info which contains a list of references to TCI-State's for the aperiodic CSI-RS resources associated with the CSI triggering state. If a State referred to in the list is configured with a reference to an RS configured with qcl-Type set to ‘typeD’, that RS may be an SS/PBCH block located in the same or different CC/DL BWP or a CSI-RS resource configured as periodic or semi-persistent located in the same or different CC/DL BWP.
. . .

For a UE configured with the higher layer parameter CSI-AperiodicTriggerStateList, if a Resource Setting linked to a CSI-ReportConfig has multiple aperiodic resource sets, only one of the aperiodic CSI-RS resource sets from the Resource Setting is associated with the trigger state, and the UE is higher layer configured per trigger state per Resource Setting to select the one CSI-IM/NZP CSI-RS resource set from the Resource Setting.

When aperiodic CSI-RS is used with aperiodic reporting, the CSI-RS offset is configured per resource set by the higher layer parameter aperiodicTriggeringOffset or aperiodicTriggeringOffset-r16 or aperiodicTriggeringOffset-r17. The CSI-RS triggering offset has the values of {0, 1, 2, 3, 4, 5, 6, . . . , 15, 16, 24} slots for μ_{CSIRS}≤3 or {0, 4, 8, 12, . . . , 60, 64, 96} slots for μ_{CSIRS}=5 and μ_{CSIRS}=6, where μ_{CSIRS} is the subcarrier spacing configurations for CSI-RS. If the UE is not configured with minimumSchedulingOffsetK0 for any DL BWP and minimumSchedulingOffsetK2 for any UL BWP and if all the associated trigger states do not have the higher layer parameter qcl-Type set to ‘typeD’ in the corresponding TCI states, the CSI-RS triggering offset is fixed to zero. The aperiodic triggering offset of the CSI-IM follows offset of the associated NZP CSI-RS for channel measurement. The aperiodic CSI-RS is transmitted in

$${K}_{s} , {K}_{S} = n + X + ⌊ ( \frac{{N}_{slot , offset , PDCCH}^{CA}}{{2}^{{μ}_{offset , PDCCH}}} - \frac{{N}_{slot , offset , CSIRS}^{CA}}{{2}^{{μ}_{offset , CSIRS}}} ) \cdot {2}^{{μ}_{CSIRS}} ⌋ ,$$

if UE is configured with ca-SlotOffset for at least one of the triggered and triggering cell, and in slot Kₛ=n+X, otherwise, and where
n is the slot containing the triggering DCI, X is the CSI-RS triggering offset according to the higher layer parameter aperiodicTriggeringOffset or aperiodicTriggeringOffset-r16 or aperiodicTriggeringOffset-r17,
N_{slot,offset,PDCCH}^{CA} and μ_{offset,PDCCH} and the N_{slot,ofset}^{CA} and the μ_{offset} which are determined by higher-layer configured ca-SlotOffset for the cell receiving the PDCCH, N_{slot,offset,CSIRS}^{CA} and μ_{offset,CSIRS} are the N_{slot,offset}^{CA} and the μ_{offset} which are determined by higher-layer configured ca-SlotOffset for the cell transmitting the CSI-RS respectively, as defined in [4, TS 38.211] clause 4.5.
   . . .

In [3] 3GPP 38.321 v17.4.0, Scheduling Request, MAC reset, activation of beam for channel(s) and TCI state activation MAC CE(s) are introduced:

### 5.4.4 Scheduling Request

The Scheduling Request (SR) is used for requesting UL-SCH resources for new transmission.

The MAC entity may be configured with zero, one, or more SR configurations. An SR configuration consists of a set of PUCCH resources for SR across different BWPs and cells. For a logical channel or for SCell beam failure recovery (see clause 5.17) and for consistent LBT failure recovery (see clause 5.21), at most one PUCCH resource for SR is configured per BWP. For a logical channel serving a radio bearer configured with SDT, PUCCH resource for SR is not configured for SDT. For beam failure recovery of BFD-RS set(s) of Serving Cell, up to two PUCCH resources for SR is configured per BWP. For positioning measurement gap activation/deactivation request, a dedicated SR configuration is configured.

Each SR configuration corresponds to one or more logical channels and/or to SCell beam failure recovery and/or to consistent LBT failure recovery and/or to beam failure recovery of a BFD-RS set and/or to positioning measurement gap activation/deactivation request. Each logical channel, SCell beam failure recovery, beam failure recovery of a BFD-RS set and consistent LBT failure recovery, may be mapped to zero or one SR configuration, which is configured by RRC. The SR configuration of the logical channel that triggered a BSR (clause 5.4.5) or the SCell beam failure recovery or the beam failure recovery of a BFD-RS set or the consistent LBT failure recovery (clause 5.21) (if such a configuration exists) or positioning measurement gap activation/deactivation request (clause 5.25) is considered as corresponding SR configuration for the triggered SR. Any SR configuration may be used for an SR triggered by Pre-emptive BSR (clause 5.4.7) or Timing Advance reporting (clause 5.4.8).

. . .

The MAC entity shall for each pending SR not triggered according to the BSR procedure (clause 5.4.5) for a Serving Cell:

| | |
|---|---|
| ... | |
| 1> | if this SR was triggered by beam failure recovery (see clause 5.17) of an SCell and a MAC PDU is transmitted and |
| | this PDU includes a MAC CE for BFR which contains beam failure recovery information for this SCell; or |
| 1> | if this SR was triggered by beam failure recovery (see clause 5.17) for a BFD-RS set of a Serving Cell and a MAC |
| | PDU is transmitted and this PDU includes an Enhanced BFR MAC CE or a Truncated Enhanced BFR MAC CE |
| | which contains beam failure recovery information for this BFD-RS set of the Serving Cell; or |
| 1> | if this SR was triggered by beam failure recovery (see clause 5.17) of an SCell and this SCell is deactivated (see |
| | clause 5.9); or |
| 1> | if this SR was triggered by beam failure recovery (see clause 5.17) for a BFD-RS set of an SCell and this SCell is |
| | deactivated (see clause 5.9); or |
| ... | |
| | 2> cancel the pending SR and stop the corresponding sr-ProhibitTimer, if running. |

Only PUCCH resources on a BWP which is active at the time of SR transmission occasion are considered valid.

As long as at least one SR is pending, the MAC entity shall for each pending SR:

| 1> | if the MAC entity has no valid PUCCH resource configured for the pending SR: | |
|---|---|---|
| | 2> | initiate a Random Access procedure (see clause 5.1) on the SpCell and cancel the pending SR. |
| 1> | else, for the SR configuration corresponding to the pending SR: | |
| | 2> | when the MAC entity has an SR transmission occasion on the valid PUCCH resource for SR configured; and |
| | 2> | if sr-ProhibitTimer is not running at the time of the SR transmission occasion; and |
| | 2> | if the PUCCH resource for the SR transmission occasion does not overlap with a measurement gap: |

| | |
|---|---|
| 3> | if the PUCCH resource for the SR transmission occasion overlaps with neither a UL-SCH resource whose |
| | simultaneous transmission with the SR is not allowed by configuration of simultaneousPUCCH-PUSCH or |
| | simultaneousPUCCH-PUSCH-SecondaryPUCCHgroup or simultaneousSR-PUSCH-diffPUCCH-Groups |
| | nor an SL-SCH resource; or |
| 3> | if the MAC entity is able to perform this SR transmission simultaneously with the transmission of the SL- |
| | SCH resource; or |

...

| | |
|---|---|
| 4> | consider the SR transmission as a prioritized SR transmission. |
| 4> | consider the other overlapping uplink grant(s), if any, as a de-prioritized uplink grant(s), except for the |
| | overlapping uplink grant(s) whose simultaneous transmission is allowed by configuration of |
| | simultaneousPUCCH-PUSCH or simultaneousPUCCH-PUSCH-SecondaryPUCCHgroup or |
| | simultaneousSR-PUSCH-diffPUCCH-Groups; |
| 4> | if the de-prioritized uplink grant(s) is a configured uplink grant configured with autonomousTx whose |
| | PUSCH has already started: |

| | |
|---|---|
| 5> | stop the configuredGrantTimer for the corresponding HARQ process of the de-prioritized uplink |
| | grant(s); |
| 5> | stop the cg-RetransmissionTimer for the corresponding HARQ process of the de-prioritized uplink |
| | grant(s). |

| | |
|---|---|
| 4> | if SR_COUNTER < sr-TransMax: |

| | |
|---|---|
| 5> | instruct the physical layer to signal the SR on one valid PUCCH resource for SR; |
| 5> | if LBT failure indication is not received from lower layers: |
| | 6> increment SR_COUNTER by 1; |
| | 6> start the sr-ProhibitTimer. |
| 5> | else if lbt-FailureRecoveryConfig is not configured: |
| | 6> increment SR_COUNTER by 1. |

| | |
|---|---|
| 4> | else: |

| | |
|---|---|
| 5> | notify RRC to release PUCCH for all Serving Cells; |
| 5> | notify RRC to release SRS for all Serving Cells; |
| 5> | clear any configured downlink assignments and uplink grants; |
| 5> | clear any PUSCH resources for semi-persistent CSI reporting; |
| 5> | initiate a Random Access procedure (see clause 5.1) on the SpCell and cancel all pending SRs. |

| | |
|---|---|
| 3> | else: |

| | |
|---|---|
| 4> | consider the SR transmission as a de-prioritized SR transmission. |

...

The MAC entity may stop, if any, ongoing Random Access procedure due to a pending SR for BSR, which was initiated by the MAC entity prior to the MAC PDU assembly and which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU includes a BSR MAC CE which contains buffer status up to (and including) the last event that triggered a BSR (see clause 5.4.5) prior to the MAC PDU assembly; or
the UL grant(s) can accommodate all pending data available for transmission.

The MAC entity may stop, if any, ongoing Random Access procedure due to a pending SR for SL-BSR and/or SL-CSI reporting and/or SL-DRX command indication, which was initiated by the MAC entity prior to the sidelink MAC PDU assembly and which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU includes an SL-BSR MAC CE which contains buffer status up to (and including) the last event that triggered an SL-BSR (see clause 5.22.1.6) prior to the MAC PDU assembly; or
the SL grant(s) can accommodate all pending data available and/or SL-CSI reporting MAC CE and/or SL-DRX command indication for transmission.

The MAC entity may stop, if any, ongoing Random Access procedure due to a pending SR for BFR of an SCell, which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU contains a MAC CE for BFR which includes beam failure recovery information of that SCell; or
the SCell is deactivated (as specified in clause 5.9) and all triggered BFRs for SCells are cancelled.

The MAC entity may stop, if any, ongoing Random Access procedure due to a pending SR for BFR of a BFD-RS set of a Serving Cell, which has no valid PUCCH resources configured, if:
a MAC PDU is transmitted using a UL grant other than a UL grant provided by Random Access Response or a UL grant determined as specified in clause 5.1.2a for the transmission of the MSGA payload, and this PDU contains an Enhanced BFR MAC CE or a Truncated Enhanced BFR MAC CE which includes beam failure recovery information of that BFD-RS set of the Serving Cell.
. . .

### 5.7 Discontinuous Reception (DRX)

The MAC entity may be configured by RRC with a DRX functionality that controls the UE's PDCCH monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SL-CS-RNTI and SL Semi-Persistent Scheduling V-RNTI. When using DRX operation, the MAC entity shall also monitor PDCCH according to requirements found in other clauses of this specification. When in RRC_CONNECTED, if DRX is configured, for all the activated Serving Cells, the MAC entity may monitor the PDCCH discontinuously using the DRX operation specified in this clause; otherwise the MAC entity shall monitor the PDCCH as specified in TS 38.213 [6].

When DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUL or drx-RetransmissionTimerSL is running on any Serving Cell in the DRX group; or
ra-ContentionResolutionTimer (as described in clause 5.1.5) or msgB-Response Window (as described in clause 5.1.4a) is running; or
a Scheduling Request is sent on PUCCH and is pending (as described in clause 5.4.4 or 5.22.1.5). If this Serving Cell is part of a non-terrestrial network, the Active Time is started after the Scheduling Request transmission that is performed when the SR_COUNTER is 0 for all the SR configurations with pending SR(s) plus the UE-gNB RTT; or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clauses 5.1.4 and 5.1.4a).

### 5.12 MAC Reset

If a reset of the MAC entity is requested by upper layers or the reset of the MAC entity is triggered due to SCG deactivation as defined in clause 5.29, the MAC entity shall:

| 1> | if the MAC reset is not due to SCG deactivation: | |
|---|---|---|
| | 2> | initialize Bj for each logical channel to zero; |
| 1> | initialize SBj for each logical channel to zero if Sidelink resource allocation mode 1 is configured by RRC; | |
| 1> | if upper layers indicate SCG deactivation and bfd-and-RLM with value true is configured for the deactivated SCG: | |
| | 2> | stop (if running) all timers except beamFailureDetectionTimer associated with PSCell and |
| | | timeAlignmentTimers. |
| 1> | else: | |
| | 2> | stop (if running) all timers, except MBS broadcast DRX timers; |
| | 2> | consider all timeAlignmentTimers, inactivePosSRS-TimeAlignmentTimer, and cg-SDT-TimeAlignmentTimer, if |
| | | configured, as expired and perform the corresponding actions in clause 5.2; |
| 1> | set the NDIs for all uplink HARQ processes to the value 0; | |
| 1> | sets the NDIs for all HARQ process IDs to the value 0 for monitoring PDCCH in Sidelink resource allocation | |
| | mode 1; | |
| 1> | stop, if any, ongoing Random Access procedure; | |
| 1> | discard explicitly signalled contention-free Random Access Resources for 4-step RA type and 2-step RA type, if | |
| | any; | |
| 1> | flush Msg3 buffer; | |
| 1> | flush MSGA buffer; | |
| 1> | cancel, if any, triggered Scheduling Request procedure; | |
| 1> | cancel, if any, triggered Buffer Status Reporting procedure; | |
| 1> | cancel, if any, triggered Power Headroom Reporting procedure; | |
| 1> | cancel, if any, triggered consistent LBT failure; | |
| 1> | cancel, if any, triggered BFR; | |
| 1> | cancel, if any, triggered Sidelink Buffer Status Reporting procedure; | |
| 1> | cancel, if any, triggered Pre-emptive Buffer Status Reporting procedure; | |
| 1> | cancel, if any, triggered Timing Advance Reporting procedure; | |
| 1> | cancel, if any, triggered Recommended bit rate query procedure; | |
| 1> | cancel, if any, triggered Configured uplink grant confirmation; | |
| 1> | cancel, if any, triggered configured sidelink grant confirmation; | |
| 1> | cancel, if any, triggered Desired Guard Symbol query; | |
| 1> | cancel, if any, triggered Positioning Measurement Gap Activation/Deactivation Request procedure; | |
| 1> | cancel, if any, triggered SDT procedure; | |
| 1> | flush the soft buffers for all DL HARQ processes, except for the DL HARQ process being used for MBS | |
| | broadcast; | |
| 1> | for each DL HARQ process, except for the DL HARQ process being used for MBS broadcast, consider the next | |
| | received transmission for a TB as the very first transmission; | |
| 1> | release, if any, Temporary C-RNTI; | |
| 1> | if upper layers indicate SCG deactivation and bfd-and-RLM with value true is not configured; or | |
| 1> | if the MAC reset is not due to SCG deactivation: | |
| | 2> | reset all BFI_COUNTERS; |

| | |
|---|---|
| 1> | reset all LBT_COUNTERs. |

### 5.18.4 Activation/Deactivation of UE-Specific PDSCH TCI State

The network may activate and deactivate the configured TCI states for PDSCH of a Serving Cell or a set of Serving Cells configured in simultaneousTCI-UpdateList1 or simultaneousTCI-UpdateList2 by sending the TCI States Activation/Deactivation for UE-specific PDSCH MAC CE described in clause 6.1.3.14. The network may activate and deactivate the configured TCI states for a codepoint of the DCI Transmission configuration indication field as specified in TS 38.212 [9] for PDSCH of a Serving Cell by sending the Enhanced TCI States Activation/Deactivation for UE-specific PDSCH MAC CE described in clause 6.1.3.24. The configured TCI states for PDSCH are initially deactivated upon (re-) configuration by upper layers and after reconfiguration with sync.

The MAC entity shall:

| 1> | if the MAC entity receives a TCI States Activation/Deactivation for UE-specific PDSCH MAC CE on a Serving | |
|---|---|---|
| | Cell: | |
| | 2> | indicate to lower layers the information regarding the TCI States Activation/Deactivation for UE-specific |
| | | PDSCH MAC CE. |
| 1> | if the MAC entity receives an Enhanced TCI States Activation/Deactivation for UE-specific PDSCH MAC CE on | |
| | a Serving Cell: | |
| | 2> | indicate to lower layers the information regarding the Enhanced TCI States Activation/Deactivation for UE- |
| | | specific PDSCH MAC CE. |

### 5.18.5 Indication of TCI State for UE-Specific PDCCH

The network may indicate a TCI state for PDCCH reception for a CORESET of a Serving Cell or a set of Serving Cells configured in simultaneousTCI-UpdateList1 or simultaneousTCI-UpdateList2 by sending the TCI State Indication for UE-specific PDCCH MAC CE described in clause 6.1.3.15. The network may also indicate two TCI states for PDCCH reception for a CORESET of a Serving Cell or a set of Serving Cells configured in simultaneousTCI-UpdateList1 or simultaneousTCI-UpdateList2 by sending the Enhanced TCI States Indication for UE-specific PDCCH MAC CE described in clause 6.1.3.44.

The MAC entity shall:

| 1> | if the MAC entity receives a TCI State Indication for UE-specific PDCCH MAC CE on a Serving Cell: | |
|---|---|---|
| | 2> | indicate to lower layers the information regarding the TCI State Indication for UE-specific PDCCH MAC CE. |
| 1> | if the MAC entity receives an Enhanced TCI States Indication for UE-specific PDCCH MAC CE on a Serving | |
| | Cell: | |
| | 2> | indicate to lower layers the information regarding the Enhanced TCI States Indication for UE-specific PDCCH |
| | | MAC CE. |

### 5.18.6 Activation/Deactivation of Semi-Persistent CSI Reporting on PUCCH

The network may activate and deactivate the configured Semi-persistent CSI reporting on PUCCH of a Serving Cell by sending the SP CSI reporting on PUCCH Activation/Deactivation MAC CE described in clause 6.1.3.16. The configured Semi-persistent CSI reporting on PUCCH is initially deactivated upon (re-) configuration by upper layers and after reconfiguration with sync.

The MAC entity shall:

| 1> | if the MAC entity receives an SP CSI reporting on PUCCH Activation/Deactivation MAC CE on a Serving Cell: | |
|---|---|---|
| | 2> | indicate to lower layers the information regarding the SP CSI reporting on PUCCH Activation/Deactivation |
| | | MAC CE. |

...

### 5.18.23 Unified TCI States Activation/Deactivation MAC CE

The network may activate and deactivate the configured unified TCI states of a Serving Cell or a set of Serving Cells configured in simultaneousU-TCI-UpdateList1, simultaneousU-TCI-UpdateList2, simultaneousU-TCI-UpdateList3 or simultaneousU-TCI-UpdateList4 by sending the Unified TCI States Activation/Deactivation MAC CE described in clause 6.1.3.47. The configured unified TCI states are initially deactivated upon (re-) configuration by upper layers and after reconfiguration with sync.

The MAC entity shall:

| | |
|---|---|
| 1> | if the MAC entity receives a Unified TCI States Activation/Deactivation MAC CE on a Serving Cell: |
| | 2> indicate to lower layers the information regarding the Unified TCI States Activation/Deactivation MAC CE. |

### 6.1.3.14 TCI States Activation/Deactivation for UE-Specific PDSCH MAC CE

The TCI States Activation/Deactivation for UE-specific PDSCH MAC CE is identified by a MAC subheader with LCID as specified in Table 6.2.1-1. It has a variable size consisting of following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID: This field indicates a DL BWP for which the MAC CE applies as the codepoint of the DCI bandwidth part indicator field as specified in TS 38.212 [9]. The length of the BWP ID field is 2 bits. This field is ignored if this MAC CE applies to a set of Serving Cells;
Tᵢ: If there is a TCI state with TCI-StateId i as specified in TS 38.331 [5], this field indicates the activation/deactivation status of the TCI state with TCI-StateId i, otherwise MAC entity shall ignore the Tᵢ field. The Tᵢ field is set to 1 to indicate that the TCI state with TCI-StateId i shall be activated and mapped to the codepoint of the DCI Transmission Configuration Indication field, as specified in TS 38.214 [7]. The Tᵢ field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. The maximum number of activated TCI states is 8. The activated TCI states can be associated with at most one PCI different from the Serving Cell PCI at a time;
CORESET Pool ID: This field indicates that mapping between the activated TCI states and the codepoint of the DCI Transmission Configuration Indication set by field Tᵢ is specific to the ControlResourceSetId configured with CORESET Pool ID as specified in TS 38.331 [5]. This field set to 1 indicates that this MAC CE shall be applied for the DL transmission scheduled by CORESET with the CORESET pool ID equal to 1, otherwise, this MAC CE shall be applied for the DL transmission scheduled by CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORSET Pool ID field shall be ignored when receiving the MAC CE.

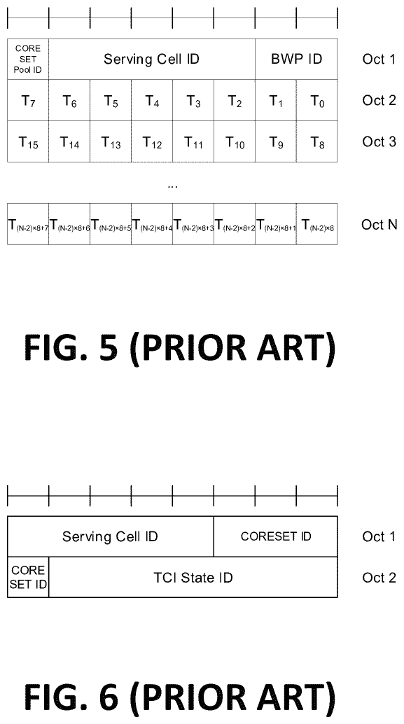

FIG. 5 is a reproduction of FIG. 6.1.3.14-1: TCI States Activation/Deactivation for UE-specific PDSCH MAC CE, from 3GPP 38.321 v17.4.0.

### 6.1.3.15 TCI State Indication for UE-Specific PDCCH MAC CE

The TCI State Indication for UE-specific PDCCH MAC CE is identified by a MAC subheader with LCID as specified in Table 6.2.1-1. It has a fixed size of 16 bits with following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all theServing Cells in the set simultaneousTCI-UpdateList1 or simultaneousTCI-UpdateList2, respectively;
CORESET ID: This field indicates a Control Resource Set identified with ControlResourceSetId as specified in TS 38.331 [5], for which the TCI State is being indicated. In case the value of the field is 0, the field refers to the Control Resource Set configured by controlResourceSetZero as specified in TS 38.331 [5]. The length of the field is 4 bits;
TCI State ID: This field indicates the TCI state identified by TCI-StateId as specified in TS 38.331 [5] applicable to the Control Resource Set identified by CORESET ID field. If the field of CORESET ID is set to 0, this field indicates a TCI-StateId for a TCI state of the first 64 TCI-states configured by tci-StatesToAddModList and tci-StatesToReleaseList in the PDSCH-Config in the active BWP or by dl-OrJoint-TCI-State-ToAddModList and dl-OrJoint-TCI-State-ToReleaseList in the PDSCH-Config in the active BWP or the reference BWP. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.

FIG. 6 is a reproduction of FIG. 6.1.3.15-1: TCI State Indication for UE-specific PDCCH MAC CE, from 3GPP 38.321 v17.4.0.

### 6.1.3.24 Enhanced TCI States Activation/Deactivation for UE-Specific PDSCH MAC CE

The Enhanced TCI States Activation/Deactivation for UE-specific PDSCH MAC CE is identified by a MAC PDU subheader with eLCID as specified in Table 6.2.1-1b. It has a variable size consisting of following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID: This field indicates a DL BWP for which the MAC CE applies as the codepoint of the DCI bandwidth part indicator field as specified in TS 38.212 [9]. The length of the BWP ID field is 2 bits;
Cᵢ: This field indicates whether the octet containing TCI state ID_{i,2} is present. If this field is set to 1, the octet containing TCI state ID_{i,2} is present. If this field is set to 0, the octet containing TCI state ID_{i,2} is not present;
TCI state ID_{i,j}: This field indicates the TCI state identified by TCI-StateId as specified in TS 38.331 [5], where i is the index of the codepoint of the DCI Transmission configuration indication field as specified in TS 38.212 [9] and TCI state ID_{i,j} denotes the j^{th} TCI state indicated for the i^{th} codepoint in the DCI Transmission Configuration Indication field. The TCI codepoint to which the TCI States are mapped is determined by its ordinal position among all the TCI codepoints with sets of TCI state ID_{i,j} fields, i.e. the first TCI codepoint with TCI state ID_{0,1} and TCI state ID_{0,2} shall be mapped to the codepoint value 0, the second TCI codepoint with TCI state ID_{1,1} and TCI state ID_{1,2} shall be mapped to the codepoint value 1 and so on. The TCI state ID_{i,2} is optional based on the indication of the Cᵢ field. The maximum number of activated TCI codepoint is 8 and the maximum number of TCI states mapped to a TCI codepoint is 2.
R: Reserved bit, set to 0.

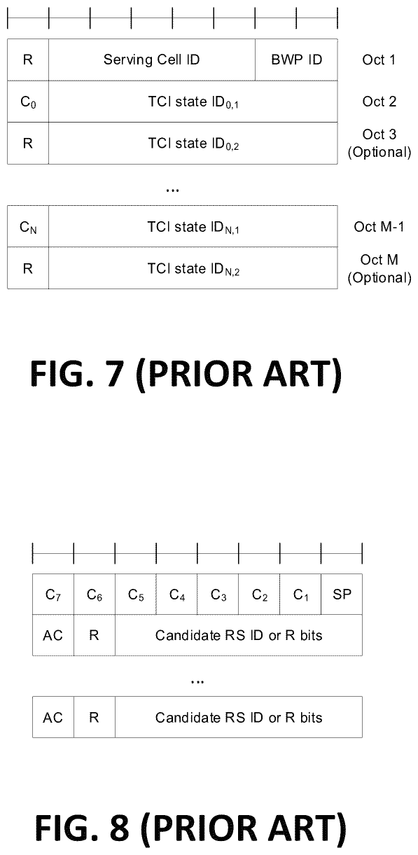

FIG. 7 is a reproduction of FIG. 6.1.3.24-1: Enhanced TCI States Activation/Deactivation for UE-specific PDSCH MAC CE, from 3GPP 38.321 v17.4.0.

### 6.1.3.23 BFR MAC CES

The MAC CEs for BFR consists of either:
BFR MAC CE; or
Truncated BFR MAC CE.

The BFR MAC CE and Truncated BFR MAC CE are identified by a MAC subheader with LCID/eLCID as specified in Table 6.2.1-2 and Table 6.2.1-2b.

The BFR MAC CE and Truncated BFR MAC CE have a variable size. They include a bitmap and in ascending order based on the ServCellIndex, beam failure recovery information i.e. octets containing candidate beam availability indication (AC) for SCells indicated in the bitmap. For BFR MAC CE, a single octet bitmap is used when the highest ServCellIndex of this MAC entity's SCell for which beam failure is detected and the evaluation of the candidate beams according to the requirements as specified in TS 38.133 has been completed is less than 8, otherwise four octets are used. A MAC PDU shall contain at most one BFR MAC CE.

For Truncated BFR MAC CE, a single octet bitmap is used for the following cases, otherwise four octets are used:
the highest ServCellIndex of this MAC entity's SCell for which beam failure is detected and the evaluation of the candidate beams according to the requirements as specified in TS 38.133 has been completed is less than 8; or
beam failure is detected for SpCell (as specified in Clause 5.17) and the SpCell is to be indicated in a Truncated BFR MAC CE and the UL-SCH resources available for transmission cannot accommodate the Truncated BFR MAC CE with the four octets bitmap plus its subheader as a result of LCP.

The fields in the BFR MAC CEs are defined as follows:
SP: This field indicates beam failure detection (as specified in clause 5.17) for the SpCell of this MAC entity. The SP field is set to 1 to indicate that beam failure is detected for SpCell only when BFR MAC CE or Truncated BFR MAC CE is to be included into a MAC PDU as part of Random Access Procedure (as specified in 5.1.3a and 5.1.4), otherwise, it is set to 0;
Cᵢ (BFR MAC CE): This field indicates beam failure detection (as specified in clause 5.17) and the presence of an octet containing the AC field for the SCell with ServCellIndex i as specified in TS 38.331 [5]. The Cᵢ field set to 1 indicates that beam failure is detected, the evaluation of the candidate beams according to the requirements as specified in TS 38.133 has been completed, and the octet containing the AC field is present for the SCell with ServCellIndex i. The Cᵢ field set to 0 indicates that the beam failure is either not detected or the beam failure is detected but the evaluation of the candidate beams according to the requirements as specified in TS 38.133 has not been completed, and the octet containing the AC field is not present for the SCell with ServCellIndex i. The octets containing the AC field are present in ascending order based on the ServCellIndex;
Cᵢ (Truncated BFR MAC CE): This field indicates beam failure detection (as specified in clause 5.17) for the SCell with ServCellIndex i as specified in TS 38.331 [5]. The Cᵢ field set to 1 indicates that beam failure is detected, the evaluation of the candidate beams according to the requirements as specified in TS 38.133 has been completed, and the octet containing the AC field for the SCell with ServCellIndex i may be present. The Cᵢ field set to 0 indicates that the beam failure is either not detected or the beam failure is detected but the evaluation of the candidate beams according to the requirements as specified in TS 38.133 has not been completed, and the octet containing the AC field is not present for the SCell with ServCellIndex i. The octets containing the AC field, if present, are included in ascending order based on the ServCellIndex. The number of octets containing the AC field included is maximised, while not exceeding the available grant size;

NOTE: The number of the octets containing the AC field in the Truncated BFR MAC CE can be zero.
AC: This field indicates the presence of the Candidate RS ID field in this octet. If at least one of the SSBs with SS-RSRP above rsrp-ThresholdBFR amongst the SSBs in candidateBeamRSSCellList or the CSI-RSs with CSI-RSRP above rsrp-ThresholdBFR amongst the CSI-RSs in candidateBeamRSSCellList is available, the AC field is set to 1; otherwise, it is set to 0. If the AC field set to 1, the Candidate RS ID field is present. If the AC field set to 0, R bits are present instead;
Candidate RS ID: This field is set to the index of an SSB with SS-RSRP above rsrp-ThresholdBFR amongst the SSBs in candidateBeamRSSCellList or to the index of a CSI-RS with CSI-RSRP above rsrp-ThresholdBFR amongst the CSI-RSs in candidateBeamRSSCellList. Index of an SSB or CSI-RS is the index of an entry in candidateBeamRSSCellList corresponding to the SSB or CSI-RS. Index 0 corresponds to the first entry in the candidateBeamRSSCellList, index 1 corresponds to the second entry in the list and so on. The length of this field is 6 bits.
R: Reserved bit, set to 0.

FIG. 8 is a reproduction of FIG. 6.1.3.23-1: BFR and Truncated BFR MAC CE with one octet Cᵢ field, from 3GPP 38.321 v17.4.0.

FIG. 9 is a reproduction of FIG. 6.1.3.23-2: BFR and Truncated BFR MAC CE with four octets Cᵢ field, from 3GPP 38.321 v17.4.0.

### 6.1.3.43 Enhanced BFR MAC CEs

The Enhanced MAC CEs for BFR consists of either:
Enhanced BFR MAC CE; or
Truncated Enhanced BFR MAC CE.

The Enhanced BFR MAC CE and Truncated Enhanced BFR MAC CE are identified by a MAC subheader with eLCID/LCID as specified in Table 6.2.1-2 and Table 6.2.1-2b.

The Enhanced BFR MAC CE and Truncated Enhanced BFR MAC CE have a variable size. They include an SP field, Cᵢ bitmap (single octet or four octets), Sⱼ bitmap (0 to 4 octets), beam failure recovery information i.e. octets containing candidate beam availability indication (AC) for BFD-RS set(s) of SpCell configured with two BFD-RS sets, and in ascending order based on ServCellIndex, beam failure recovery information i.e. octets containing candidate beam availability indication (AC) for SCells or BFD-RS set(s) of SCells configured with two BFD-RS sets indicated in the Cᵢ bitmap. For Enhanced BFR MAC CE, a single octet Cᵢ bitmap is used when the highest ServCellIndex of this MAC entity's SCell for which beam failure is detected for SCell or for at least one BFD-RS set of SCell and the evaluation of the candidate beams according to the requirements as specified in TS 38.133 has been completed is less than 8, otherwise four octets Cᵢ bitmap is used. A MAC PDU shall contain at most one MAC CE for BFR.

For Truncated Enhanced BFR MAC CE, a single octet Cᵢ bitmap is used for the following cases, otherwise four octets Cᵢ bitmap is used:
the highest ServCellIndex of this MAC entity's SCell for which beam failure is detected for SCell or for at least one BFD-RS set of SCell and the evaluation of the candidate beams according to the requirements as specified in TS 38.133 has been completed is less than 8; or
beam failure is detected for SpCell (as specified in Clause 5.17) not configured with two BFD-RS sets, and the SpCell is to be indicated in a Truncated Enhanced BFR MAC CE and the UL-SCH resources available for transmission cannot accommodate the Truncated Enhanced BFR MAC CE with the four octets Cᵢ bitmap plus its subheader as a result of LCP; or
Random Access procedure is initiated for beam failure recovery of both BFD-RS sets of SpCell (as specified in Clause 5.17) configured with two BFD-RS sets and the SpCell is to be indicated in a Truncated Enhanced BFR MAC CE and the UL-SCH resources available for transmission cannot accommodate the Truncated Enhanced BFR MAC CE with the four octets Ci bitmap plus its subheader as a result of LCP.

For Enhanced BFR MAC CE and Truncated Enhanced BFR MAC CE, a single octet Sₖ bitmap is included if the total number of Serving Cells configured with two BFD-RS sets for which SP/Cᵢ field set to 1 is greater than 0 and less than 9; a two octets Sₖ bitmap is included if the total number of Serving Cells configured with two BFD-RS sets for which SP/Cᵢ field set to 1 is greater than 8 and less than 17; a three octets Sₖ bitmap is included if the total number of Serving Cells configured with two BFD-RS sets for which SP/Cᵢ field is set to 1 is greater than 16 and less than 25; a four octets Sₖ bitmap is included if the total number of Serving Cells configured with two BFD-RS sets for which SP/Cᵢ field set to 1 is greater than 24; Sₖ bitmap is not included if the total number of Serving Cells configured with two BFD-RS sets for which SP/Cᵢ field is set to 1 is zero.

For Truncated Enhanced BFR MAC CE, octet(s) containing the AC field, if any, are included for SpCell first, then one octet containing the AC field is included for SCell(s) (in ascending order of the ServCellIndex) and then the second octet containing the AC field, if any, is included for SCell(s) (in ascending order of the ServCellIndex), while not exceeding the available grant size. The number of the octets containing the AC field in the Truncated Enhanced BFR MAC CE can be zero.

The fields in the Enhanced BFR MAC CEs are defined as follows:
SP (Enhanced BFR MAC CE): This field indicates beam failure detection (as specified in clause 5.17) for the SpCell of this MAC entity and the presence of octet(s) containing the AC field if the SpCell is configured with multiple BFD-RS sets. For the SpCell configured with two BFD-RS sets, this field set to 1 indicates that beam failure is detected for at least one BFD-RS set, the evaluation of the candidate beams according to the requirements as specified in TS 38.133 has been completed, and the octet(s) containing the AC field is present for the SpCell; otherwise, it is set to 0. The octet(s) containing the AC field for SpCell are included before those of SCell(s). For the SpCell not configured with multiple BFD-RS sets, the SP field is set to 1 to indicate that beam failure is detected for SpCell when Enhanced BFR MAC CE is to be included into a MAC PDU as part of Random Access Procedure (as specified in 5.1.3a and 5.1.4); otherwise, it is set to 0;
SP (Truncated Enhanced BFR MAC CE): This field indicates beam failure detection (as specified in clause 5.17) for the SpCell of this MAC entity. For the SpCell configured with two BFD-RS sets, this field set to 1 indicates that beam failure is detected for at least one BFD-RS set, the evaluation of the candidate beams according to the requirements as specified in TS 38.133 has been completed, and the octet(s) containing the AC field may be present for the SpCell; otherwise, it is set to 0. For the SpCell not configured with multiple BFD-RS sets, the SP field is set to 1 to indicate that beam failure is detected for SpCell when Truncated Enhanced BFR MAC CE is to be included into a MAC PDU as part of Random Access Procedure (as specified in 5.1.3a and 5.1.4); otherwise, it is set to 0;
Cᵢ (Enhanced BFR MAC CE): This field indicates beam failure detection (as specified in clause 5.17) and the presence of octet(s) containing the AC field for the SCell with ServCellIndex i as specified in TS 38.331 [5]. The Cᵢ field set to 1 indicates that beam failure is detected for the SCell or at least one BFD-RS set of the SCell, the evaluation of the candidate beams according to the requirements as specified in TS 38.133 has been completed, and the octet(s) containing the AC field is present for the SCell with ServCellIndex i. The Cᵢ field set to 0 indicates either that the beam failure is not detected for the SCell or any BFD-RS set of the SCell, and the octet(s) containing the AC field is not present for the SCell with ServCellIndex i; or that the beam failure is detected for the SCell or at least one BFD-RS set of the SCell but the evaluation of the candidate beams according to the requirements as specified in TS 38.133 has not been completed, and the octets containing the AC field is not present for the SCell with ServCellIndex i. The octets containing the AC field are present in ascending order based on the ServCellIndex and are included after the octet(s) containing the AC field for SpCell, if any;
Cᵢ (Truncated Enhanced BFR MAC CE): This field indicates beam failure detection (as specified in clause 5.17) for the SCell with ServCellIndex i as specified in TS 38.331 [5]. The Cᵢ field set to 1 indicates that beam failure is detected for the SCell or at least one BFD-RS set of the SCell, the evaluation of the candidate beams according to the requirements as specified in TS 38.133 has been completed, and the octet(s) containing the AC field for the SCell with ServCellIndex i may be present. The Cᵢ field set to 0 indicates either that the beam failure is not detected for the SCell or any BFD-RS set of the SCell, and the octet(s) containing the AC field is not present for the SCell with ServCellIndex i; or that the beam failure is detected for the SCell or at least one BFD-RS set of the SCell but the evaluation of the candidate beams according to the requirements as specified in TS 38.133 has not been completed, and the octet(s) containing the AC field is not present for the SCell with ServCellIndex i;
Sₖ (Enhanced BFR MAC CE): This field corresponds to the kth Serving Cell for which SP/Cᵢ field is set to 1 and is configured with two BFD-RS sets. The Serving Cells for which SP/Cᵢ field is set to 1 and are configured with two BFD-RS sets, are indexed sequentially starting with SpCell and followed by SCells in ascending order of ServCellIndex i. This field indicates whether beam failure is detected for one or both BFD-RS sets and presence of one or two octets containing the AC field of the Serving Cell. The Sₖ field set to 1 indicates that beam failure is detected for both the BFD-RS sets, the evaluation of the candidate beams according to the requirements as specified in TS 38.133 has been completed for both the BFD-RS sets, and the octets containing the AC field are present for both the BFD-RS sets, of the Serving Cell. The Sₖ field set to 0 indicates that beam failure is either detected for one of the BFD-RS sets and the evaluation of the candidate beams according to the requirements as specified in TS 38.133 has been completed or beam failure is detected for both the BFD-RS sets but the evaluation of the candidate beams according to the requirements as specified in TS 38.133 has not been completed for both the BFD-RS sets, and the octet containing the AC field is present for only one BFD-RS set of the Serving Cell. The Sₖ field not mapped to any Serving Cell is set to 0;
Sₖ (Truncated Enhanced BFR MAC CE): This field corresponds to the kth Serving Cell for which SP/Cᵢ field is set to 1 and is configured with two BFD-RS sets. The Serving Cells for which SP/Cᵢ field is set to 1 and are configured with two BFD-RS sets, are indexed sequentially starting with SpCell and followed by SCells in ascending order of ServCellIndex i. This field indicates whether beam failure is detected for one or both BFD-RS sets of the Serving Cell. The Sₖ field set to 1 indicates that beam failure is detected for both the BFD-RS sets, the evaluation of the candidate beams according to the requirements as specified in TS 38.133 has been completed for both the BFD-RS sets, and the octet containing the AC field is present for zero, one or two BFD-RS sets of the Serving Cell. The Sₖ field set to 0 indicates that beam failure is either detected for one of the BFD-RS sets and the evaluation of the candidate beams according to the requirements as specified in TS 38.133 has been completed or beam failure is detected for both the BFD-RS sets but the evaluation of the candidate beams according to the requirements as specified in TS 38.133 has not been completed for both the BFD-RS sets, and the octet containing the AC field is present for zero or one BFD-RS set of the Serving Cell. The Sₖ field not mapped to any Serving Cell is set to 0;
AC: This field indicates the presence of the Candidate RS ID field in this octet. If at least one of the SSBs with SS-RSRP above rsrp-ThresholdBFR amongst the SSBs in list of candidate beams (i.e. candidateBeamRS-List-r16 for the SCell not configured with two BFD-RS sets, candidateBeamRS-List-r16 or candidateBeamRS-List2-r17 for Serving Cell configured with two BFD-RS sets) or the CSI-RSs with CSI-RSRP above rsrp-ThresholdBFR amongst the CSI-RSs in list of candidate beams is available, the AC field is set to 1; otherwise, it is set to 0. If the AC field set to 1, the Candidate RS ID field is present. If the AC field set to 0, R bits are present instead;
ID: This field indicates the identity of the BFD-RS set. It is set to 0 if this octet corresponds to BFD-RS set one, failureDetectionSet1-r17. It is set to 1 if this octet corresponds to BFD-RS set two, failureDetectionSet2-r17. For the Serving cell not configured with two BFD-RS sets, this field is set to 0;
Candidate RS ID: This field is set to the index of an SSB with SS-RSRP above rsrp-ThresholdBFR amongst the SSBs in list of candidate beams (i.e. candidateBeamRS-List-r16 for the SCell not configured with two BFD-RS sets, candidateBeamRS-List-r16 or candidateBeamRS-List2-r17 for Serving Cell configured with two BFD-RS sets) or to the index of a CSI-RS with CSI-RSRP above rsrp-ThresholdBFR amongst the CSI-RSs in the list of candidate beams. Index of an SSB or CSI-RS is the index of an entry in the list of candidate beams corresponding to the SSB or CSI-RS. Index 0 corresponds to the first entry in the list of candidate beams, index 1 corresponds to the second entry in the list and so on. The length of this field is 6 bits;
R: Reserved bit, set to 0.

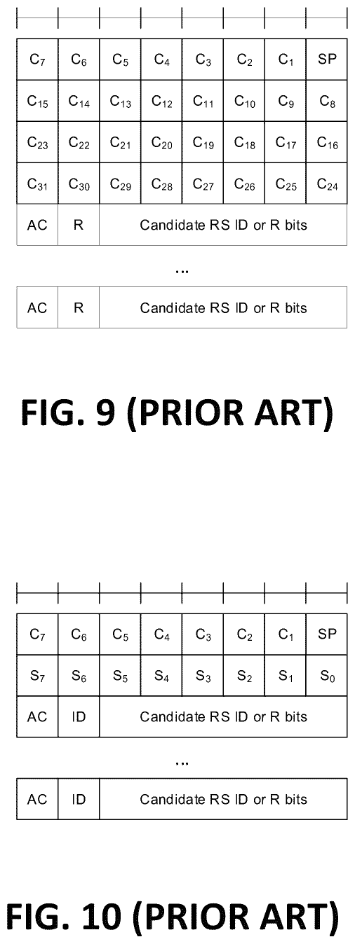

FIG. 10 is a reproduction of FIG. 6.1.3.43-1: Enhanced BFR and Truncated Enhanced BFR MAC CE with one octet Cᵢ field, from 3GPP 38.321 v17.4.0.

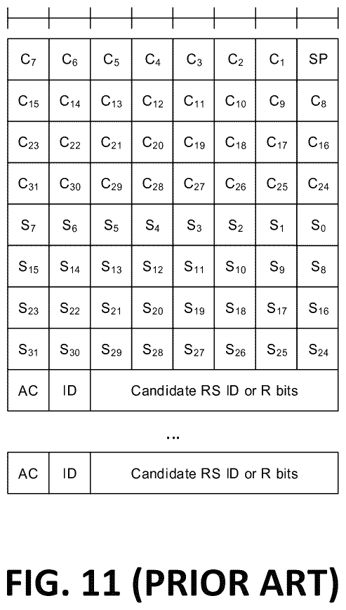

FIG. 11 is a reproduction of FIG. 6.1.3.43-2: Enhanced BFR and Truncated Enhanced BFR MAC CE with four octets Cᵢ field, from 3GPP 38.321 v17.4.0.

### 6.1.3.44 Enhanced TCI States Indication for UE-Specific PDCCH MAC CE

The Enhanced TCI States Indication for UE-specific PDCCH MAC CE is identified by a MAC PDU subheader with eLCID as specified in Table 6.2.1-1b. It has a fixed size of 24 bits with following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all theServing Cells in the set simultaneousTCI-UpdateList1 or simultaneousTCI-UpdateList2, respectively;
CORESET ID: This field indicates a Control Resource Set identified with ControlResourceSetId as specified in TS 38.331 [5], for which the TCI State is being indicated. In case the value of the field is 0, the field refers to the Control Resource Set configured by controlResourceSetZero as specified in TS 38.331 [5]. The length of the field is 4 bits;
TCI state IDi: This field indicates the TCI state identified by TCI-StateId as specified in TS 38.331 [5] applicable to the Control Resource Set identified by CORESET ID field. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.
NOTE 1: The Enhanced TCI State Indication for UE specific PDCCH MAC CE is not applicable to any of the configured CORESETs in a BWP if the CORESETs are configured with different CORESETPoolindex values in the BWP.
NOTE 2: The Enhanced TCI State Indication for UE specific PDCCH MAC CE is applied only if sfnSchemePdcch is configured.
NOTE 3: The Enhanced TCI State Indication for UE specific PDCCH MAC CE is not applicable to the CORESET configured by controlResourceSetZero if the CORESET is associated with the search space configured by pdcch-ConfigSIB1 in MIB, or searchSpaceSIB1, searchSpaceZero, searchSpaceOtherSystemInformation, or pagingSearchSpace in PDCCH-ConfigCommon.

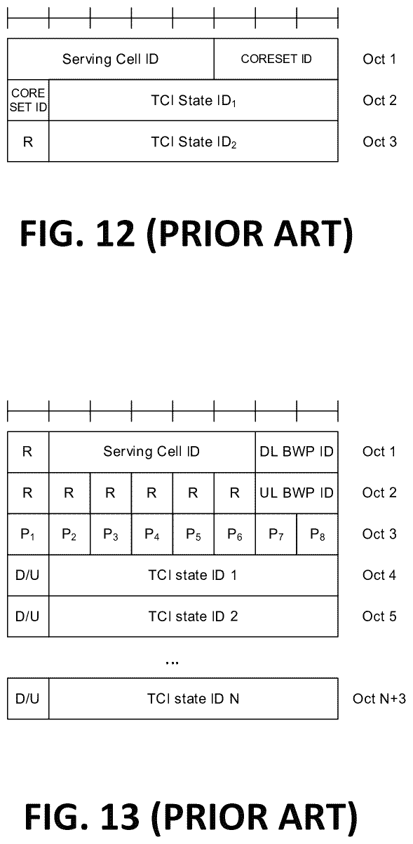

FIG. 12 is a reproduction of FIG. 6.1.3.44-1: Enhanced TCI States Indication for UE-specific PDCCH MAC CE, from 3GPP 38.321 v17.4.0.

### 6.1.3.47 Unified TCI States Activation/Deactivation MAC CE

The Unified TCI States Activation/Deactivation MAC CE is identified by a MAC subheader with eLCID as specified in Table 6.2.1-1b. It has a variable size consisting of following fields:
Serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in TS 38.331 [5], this MAC CE applies to all theServing Cells in the set simultaneousU-TCI-UpdateList1, simultaneousU-TCI-UpdateList2, simultaneousU-TCI-UpdateList3 or simultaneousU-TCI-UpdateList4, respectively;
DL BWP ID: This field indicates a DL BWP for which the MAC CE applies as the codepoint of the DCI bandwidth part indicator field as specified in TS 38.212 [9]. The length of the BWP ID field is 2 bits;
UL BWP ID: This field indicates a UL BWP for which the MAC CE applies as the codepoint of the DCI bandwidth part indicator field as specified in TS 38.212 [9]. If value of unifiedTCI-StateType in the Serving Cell indicated by Serving Cell ID is joint, this field is considered as the reserved bits. The length of the BWP ID field is 2 bits;
Pᵢ: This field indicates whether each TCI codepoint has multiple TCI states or single TCI state. If Pᵢ field is set to 1, it indicates that i^{th} TCI codepoint includes the DL TCI state and the UL TCI state. If Pᵢ field is set to 0, it indicates that i^{th} TCI codepoint includes only the DL/joint TCI state or the UL TCI state. The codepoint to which a TCI state is mapped is determined by its ordinal position among all the TCI state ID fields;
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId as specified in TS 38.331 [5]. If D/U is set to 1, 7-bits length TCI state ID i.e. TCI-StateId as specified in TS 38.331 [5] is used. If D/U is set to 0, the most significant bit of TCI state ID is considered as the reserved bit and remainder 6 bits indicate the TCI-UL-State-Id as specified in TS 38.331 [5]. The maximum number of activated TCI states is 16;
R: Reserved bit, set to 0.

FIG. 13 is a reproduction of FIG. 6.1.3.47-1: Unified TCI state activation/deactivation MAC CE, from 3GPP 38.321 v17.4.0.

In [4] 3GPP 38.331 v17.4.0, measurement events are introduced:

### 5.5.4 Measurement Report Triggering

### 5.5.4.1 General

If AS security has been activated successfully, the UE shall:

| 1> | for each measId included in the measIdList within VarMeasConfig: | |
|---|---|---|
| | 2> | if the corresponding reportConfig includes a reportType set to eventTriggered or periodical: |

| | |
|---|---|
| 3> | if the corresponding measObject concerns NR: |

| | |
|---|---|
| 4> | if the corresponding reportConfig includes measRSSI-ReportConfig: |

| | |
|---|---|
| 5> | consider the resource indicated by the rmtc-Config on the associated frequency to be applicable; |

| | |
|---|---|
| 4> | if the eventA1 or eventA2 is configured in the corresponding reportConfig: |

| | |
|---|---|
| 5> | consider only the serving cell to be applicable; |

| | |
|---|---|
| 4> | if the eventA3 or eventA5 is configured in the corresponding reportConfig: |

| | |
|---|---|
| 5> | if a serving cell is associated with a measObjectNR and neighbours are associated with another |
| | measObjectNR, consider any serving cell associated with the other measObjectNR to be a |
| | neighbouring cell as well; |

| | |
|---|---|
| 4> | if corresponding reportConfig includes reportType set to periodical; or |
| 4> | for measurement events other than eventA1, eventA2, eventD1 or eventX2: |

| | |
|---|---|
| 5> | if useAllowedCellList is set to true: |

| | |
|---|---|
| 6> | consider any neighbouring cell detected based on parameters in the associated measObjectNR to |
| | be applicable when the concerned cell is included in the allowedCellsToAddModList defined |
| | within the VarMeasConfig for this measId; |

| | |
|---|---|
| 5> | else: |

| | |
|---|---|
| 6> | consider any neighbouring cell detected based on parameters in the associated measObjectNR to |
| | be applicable when the concerned cell is not included in the excludedCellsToAddModList |
| | defined within the VarMeasConfig for this measId; |

| | |
|---|---|
| | ... |
| 2> | if the reportType is set to eventTriggered and if the entry condition applicable for this event, i.e. the event |
| | corresponding with the eventId of the corresponding reportConfig within VarMeasConfig, is fulfilled for one |
| | or more applicable cells for all measurements after layer 3 filtering taken during timeToTrigger defined for this |
| | event within the VarMeasConfig, while the VarMeasReportList does not include a measurement reporting |
| | entry for this measId (a first cell triggers the event): |

| 3> | include a measurement reporting entry within the VarMeasReportList for this measId; | |
|---|---|---|
| 3> | set the numberOfReportsSent defined within the VarMeasReportList for this measId to 0; | |
| 3> | include the concerned cell(s) in the cellsTriggeredList defined within the VarMeasReportList for this | |
| | measId; | |
| 3> | | if useT312 is set to true in reportConfig for this event: |
| | 4> | if T310 for the corresponding SpCell is running; and |
| | 4> | if T312 is not running for corresponding SpCell: |

| | |
|---|---|
| 5> | start timer T312 for the corresponding SpCell with the value of T312 configured in the |
| | corresponding measObjectNR; |

| | |
|---|---|
| 3> | initiate the measurement reporting procedure, as specified in 5.5.5; |

| | |
|---|---|
| 2> | else if the reportType is set to eventTriggered and if the entry condition applicable for this event, i.e. the event |
| | corresponding with the eventId of the corresponding reportConfig within VarMeasConfig, is fulfilled for one |
| | or more applicable cells not included in the cellsTriggeredList for all measurements after layer 3 filtering taken |
| | during timeToTrigger defined for this event within the VarMeasConfig (a subsequent cell triggers the event): |

| | |
|---|---|
| 3> | set the numberOfReportsSent defined within the VarMeasReportList for this measId to 0; |
| 3> | include the concerned cell(s) in the cellsTriggeredList defined within the VarMeasReportList for this |

measId;

| | | |
|---|---|---|
| 3> | | if useT312 is set to true in reportConfig for this event: |
| | 4> | if T310 for the corresponding SpCell is running; and |
| | 4> | if T312 is not running for corresponding SpCell: |

| | |
|---|---|
| 5> | start timer T312 for the corresponding SpCell with the value of T312 configured in the |
| | corresponding measObjectNR; |

| | |
|---|---|
| 3> | initiate the measurement reporting procedure, as specified in 5.5.5; |

| | |
|---|---|
| 2> | if the reportType is set to eventTriggered and if the leaving condition applicable for this event is fulfilled for |
| | one or more of the cells included in the cellsTriggeredList defined within the VarMeasReportList for this |
| | measId for all measurements after layer 3 filtering taken during timeToTrigger defined within the |
| | VarMeasConfig for this event: |

| | |
|---|---|
| 3> | remove the concerned cell(s) in the cellsTriggeredList defined within the VarMeasReportList for this |
| | measId; |
| 3> | if reportOnLeave is set to true for the corresponding reporting configuration: |

| | |
|---|---|
| 4> | initiate the measurement reporting procedure, as specified in 5.5.5; |

| | |
|---|---|
| 3> | if the cellsTriggeredList defined within the VarMeasReportList for this measId is empty: |

| | |
|---|---|
| 4> | remove the measurement reporting entry within the VarMeasReportList for this measId; |
| 4> | stop the periodical reporting timer for this measId, if running; |

...

| | |
|---|---|
| 2> | else if the reportType is set to eventTriggered and if the entry condition applicable for this event, i.e. the event |
| | corresponding with the eventId of the corresponding reportConfig within VarMeasConfig, is fulfilled for one |
| | or more applicable transmission resource pools for all measurements taken during timeToTrigger defined for |
| | this event within the VarMeasConfig, while the VarMeasReportList does not include an measurement reporting |
| | entry for this measld (a first transmission resource pool triggers the event): |

| | |
|---|---|
| 3> | include a measurement reporting entry within the VarMeasReportList for this measId; |
| 3> | set the numberOfReportsSent defined within the VarMeasReportList for this measId to 0; |
| 3> | include the concerned transmission resource pool(s) in the poolsTriggeredList defined within the |
| | VarMeasReportList for this measId; |
| 3> | initiate the measurement reporting procedure, as specified in 5.5.5; |

| | |
|---|---|
| | ... |
| 2> | if reportType is set to periodical and if a (first) measurement result is available: |

| | |
|---|---|
| 3> | include a measurement reporting entry within the VarMeasReportList for this measId; |
| 3> | set the numberOfReportsSent defined within the VarMeasReportList for this measId to 0; |
| 3> | if the corresponding reportConfig includes measRSSI-ReportConfig: |

| | |
|---|---|
| 4> | initiate the measurement reporting procedure as specified in 5.5.5 immediately when RSSI sample |
| | values are reported by the physical layer after the first L1 measurement duration; |

| | |
|---|---|
| 3> | else if the corresponding reportConfig includes the ul-DelayValueConfig: |

| | |
|---|---|
| 4> | initiate the measurement reporting procedure, as specified in 5.5.5, immediately after a first |
| | measurement result is provided from lower layers of the associated DRB identity; |

| | |
|---|---|
| 3> | else if the corresponding reportConfig includes the ul-ExcessDelayConfig: |

| | |
|---|---|
| 4> | initiate the measurement reporting procedure, as specified in 5.5.5, immediately after a first |
| | measurement result is provided from lower layers of the associated DRB identity(ies) according to the |
| | configured threshold per DRB identity(ies); |

| | |
|---|---|
| 3> | else if the reportAmount exceeds 1: |

| | |
|---|---|
| 4> | initiate the measurement reporting procedure, as specified in 5.5.5, immediately after the quantity to be |
| | reported becomes available for the NR SpCell or for the serving L2 U2N Relay UE (if the UE is a L2 |
| | U2N Remote UE); |

| | |
|---|---|
| 3> | else (i.e. the reportAmount is equal to 1): |

| | |
|---|---|
| 4> | initiate the measurement reporting procedure, as specified in 5.5.5, immediately after the quantity to be |
| | reported becomes available for the NR SpCell and for the strongest cell among the applicable cells, or |
| | for the NR SpCell and for the strongest L2 U2N Relay UEs among the applicable L2 U2N Relay UEs; |
| | or initiate the measurement reporting procedure, as specified in 5.5.5, immediately after the quantity to |
| | be reported becomes available for the serving L2 U2N Relay UE and for the strongest cell among the |
| | applicable cells (if the UE is a L2 U2N Remote UE); |

| | |
|---|---|
| 2> | upon expiry of the periodical reporting timer for this measId: |

| | |
|---|---|
| 3> | initiate the measurement reporting procedure, as specified in 5.5.5. |

...

5.5.4.3 Event A2 (Serving Becomes Worse than Threshold)

The UE shall:

```
  1> consider the entering condition for this event to be satisfied when condition A2-1, as specified below, is fulfilled;
  1> consider the leaving condition for this event to be satisfied when condition A2-2, as specified below, is fulfilled;
  1> for this measurement, consider the serving cell indicated by the measObjectNR associated to this event.
Inequality A2-1 (Entering condition)
Ms + Hys < Thresh
Inequality A2-2 (Leaving condition)
Ms − Hys > Thresh
```

The variables in the formula are defined as follows:
Ms is the measurement result of the serving cell, not taking into account any offsets.
Hys is the hysteresis parameter for this event (i.e. hysteresis as defined within reportConfigNR for this event).
Thresh is the threshold parameter for this event (i.e. a2-Threshold as defined within reportConfigNR for this event).
Ms is expressed in dBm in case of RSRP, or in dB in case of RSRQ and RS-SINR.
Hys is expressed in dB.
Thresh is expressed in the same unit as Ms.
   5.5.4.4 Event A3 (Neighbour Becomes Offset Better than SpCell)

The UE shall:

```
  1> consider the entering condition for this event to be satisfied when condition A3-1, as specified below, is fulfilled;
  1> consider the leaving condition for this event to be satisfied when condition A3-2, as specified below, is fulfilled;
  1> use the SpCell for Mp, Ofp and Ocp.
```

| | |
|---|---|
| NOTE 1: | The cell(s) that triggers the event has reference signals indicated in the measObjectNR associated to this |
| | event which may be different from the NR SpCell measObjectNR. |

Inequality A3-1 (Entering condition)
Mn + Ofn + Ocn − Hys > Mp + Ofp + Ocp + Off
Inequality A3-2 (Leaving condition)
Mn + Ofn + Ocn + Hys < Mp + Ofp + Ocp + Off

The variables in the formula are defined as follows:
Mn is the measurement result of the neighbouring cell, not taking into account any offsets.
Ofn is the measurement object specific offset of the reference signal of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the frequency of the neighbour cell), and set to zero if not configured for the neighbour cell.
Mp is the measurement result of the SpCell, not taking into account any offsets.
Ofp is the measurement object specific offset of the SpCell (i.e. offsetMO as defined within measObjectNR corresponding to the SpCell).
Ocp is the cell specific offset of the SpCell (i.e. cellIndividualOffset as defined within measObjectNR corresponding to the SpCell), and is set to zero if not configured for the SpCell.
Hys is the hysteresis parameter for this event (i.e. hysteresis as defined within reportConfigNR for this event).
Off is the offset parameter for this event (i.e. a3-Offset as defined within reportConfigNR for this event).
Mn, Mp are expressed in dBm in case of RSRP, or in dB in case of RSRQ and RS-SINR.
Ofn, Ocn, Ofp, Ocp, Hys, Off are expressed in dB.
NOTE 2: The definition of Event A3 also applies to CondEvent A3.
   5.5.4.5 Event A4 (Neighbour Becomes Better than Threshold)

The UE shall:

```
  1> consider the entering condition for this event to be satisfied when condition A4-1, as specified below, is fulfilled;
  1> consider the leaving condition for this event to be satisfied when condition A4-2, as specified below, is fulfilled.
Inequality A4-1 (Entering condition)
Mn + Ofn + Ocn − Hys > Thresh
Inequality A4-2 (Leaving condition)
Mn + Ofn + Ocn + Hys < Thresh
```

The variables in the formula are defined as follows:
Mn is the measurement result of the neighbouring cell, not taking into account any offsets.
Ofn is the measurement object specific offset of the neighbour cell (i.e. offsetMO as defined within measObjectNR corresponding to the neighbour cell).
Ocn is the measurement object specific offset of the neighbour cell (i.e. cellIndividualOffset as defined within measObjectNR corresponding to the neighbour cell), and set to zero if not configured for the neighbour cell.
Hys is the hysteresis parameter for this event (i.e. hysteresis as defined within reportConfigNR for this event).
Thresh is the threshold parameter for this event (i.e. a4-Threshold as defined within reportConfigNR for this event).
Mn is expressed in dBm in case of RSRP, or in dB in case of RSRQ and RS-SINR.
Ofn, Ocn, Hys are expressed in dB.
Thresh is expressed in the same unit as Mn.
NOTE: The definition of Event A4 also applies to CondEvent A4.
   5.5.4.6 Event A5 (SpCell Becomes Worse than Threshold1 and Neighbour Becomes Better than Threshold2)

The UE shall:

| | |
|---|---|
| 1> | consider the entering condition for this event to be satisfied when both condition A5-1 and condition A5-2, as |
| | specified below, are fulfilled; |
| 1> | consider the leaving condition for this event to be satisfied when condition A5-3 or condition A5-4, i.e. at least |
| | one of the two, as specified below, is fulfilled; |
| 1> | use the SpCell for Mp. |

| NOTE 1: | The parameters of the reference signal(s) of the cell(s) that triggers the event are indicated in the |
|---|---|
| | measObjectNR associated to the event which may be different from the measObjectNR of the NR SpCell. |

Inequality A5-1 (Entering condition 1)
Mp + Hys < Thresh1
Inequality A5-2 (Entering condition 2)
Mn + Ofn + Ocn − Hys > Thresh2
Inequality A5-3 (Leaving condition 1)
Mp − Hys > Thresh1
Inequality A5-4 (Leaving condition 2)
Mn + Ofn + Ocn + Hys < Thresh2

The variables in the formula are defined as follows:
Mp is the measurement result of the NR SpCell, not taking into account any offsets.
Mn is the measurement result of the neighbouring cell, not taking into account any offsets.
Ofn is the measurement object specific offset of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the neighbour cell), and set to zero if not configured for the neighbour cell.
Hys is the hysteresis parameter for this event (i.e. hysteresis as defined within reportConfigNR for this event).
Thresh1 is the threshold parameter for this event (i.e. a5-Threshold1 as defined within reportConfigNR for this event).
Thresh2 is the threshold parameter for this event (i.e. a5-Threshold2 as defined within reportConfigNR for this event).
Mn, Mp are expressed in dBm in case of RSRP, or in dB in case of RSRQ and RS-SINR.
Ofn, Ocn, Hys are expressed in dB.
Thresh1 is expressed in the same unit as Mp.
Thresh2 is expressed in the same unit as Mn.
NOTE 2: The definition of Event A5 also applies to CondEvent A5.
   . . .

In [5] Draft 38.300 v 18.0.0, L1/L2 mobility (LTM) is introduced:

### 9.2.3.5 L1/L2-Triggered Mobility

### 9.2.3.5.1 General

LTM is a procedure in which a gNB receives L1 measurement report(s) from a UE, and on their basis the gNB changes UE serving cell by a cell switch command signalled via a MAC CE. The cell switch command indicates an LTM candidate configuration that the gNB previously prepared and provided to the UE through RRC signalling. Then the UE switches to the target configuration according to the cell switch command. The LTM procedure can be used to reduce the mobility latency as described in Annex G.

When configured by the network, it is possible to activate TCI states of one or multiple cells that are different from the current serving cell. For instance, the TCI states of the LTM candidate cells can be activated in advance before any of those cells become the serving cell. This allows the UE to be DL synchronized with those cells, thereby facilitating a faster cell switch to one of those cells when cell switch is triggered.

When configured by the network, it is possible to initiate UL TA acquisition (called early TA) procedure of one or multiple cells that are different from the current serving cells. If the cell has the same N_{TA} as the current serving cells or N_{TA}=0, early TA acquisition procedure is not required. The network may request the UE to perform early TA acquisition of a candidate cell before a cell switch. The early TA acquisition procedure is triggered by PDCCH order as specified in clause 9.2.6 or realized through UE-based TA measurement as configured by RRC. In the former case, the gNB to which the candidate cell belongs calculates the TA value and sends it to the gNB to which the serving cell belongs. The serving cell sends the TA value in the LTM cell switch command MAC CE when triggering LTM cell switch. In the latter case, the UE performs TA measurement for the candidate cells after being configured by RRC but the exact time the UE performs TA measurement is up to UE implementation. The UE applies the TA value measured by itself and performs RACH-less LTM upon receiving the cell switch command. The network may also send a TA value in the LTM cell switch command MAC CE without early TA acquisition.

Depending on the availability of a valid TA value, the UE performs either a RACH-less LTM or RACH-based LTM cell switch. If the TA value is provided in the cell switch command, the UE applies the TA value as instructed by the network. In the case where UE-based TA measurement is configured, but no TA value is provided in the cell switch command, the UE applies the TA value by itself if available. Meanwhile, the UE performs RACH-less LTM cell switch upon receiving the cell switch command. If no valid TA value is available, the UE performs RACH-based LTM cell switch.

Regardless of whether the UE is configured for UE-based TA measurement for a certain candidate cell, it will still follow the PDCCH order, which includes requesting a random access procedure towards the candidate cells. This also applies to the candidate cells for which the UE is capable of deriving TA values by itself. Additionally, regardless of whether the UE has already performed a random access procedure towards the candidate cells, it will still follow the UE-based measurement configuration if configured by the network.

For RACH-less LTM, the UE accesses the target cell using either a configured grant or a dynamic grant. The configured grant is provided in the LTM candidate configuration, and the UE selects the configured grant occasion associated with the beam indicated in the cell switch command. Upon initiation of LTM cell switch to the target cell, the UE starts to monitor PDCCH on the target cell for dynamic scheduling. Before RACH-less LTM procedure completion, the UE shall not trigger random access procedure if it does not have a valid PUCCH resource for triggered SRs.

The following principles apply to LTM:
Security key is maintained upon an LTM cell switch;
Subsequent LTM is supported.

LTM supports both intra-gNB-DU and intra-gNB-CU inter-gNB-DU mobility. LTM supports both intra-frequency and inter-frequency mobility, including mobility to inter-frequency cell that is not a current serving cell. LTM is supported only for licensed spectrum. The following scenarios are supported:
PCell change in non-CA scenario and non-DC scenario;
PCell and SCell(s) change in CA scenario;
Dual connectivity scenario, PCell and MCG SCell(s) change and intra-SN PSCell and SCG SCell(s) change without MN involvement. LTM for simultaneous PCell and PSCell change is not supported.

While the UE has stored LTM candidate configurations the UE can also execute any L3 handover command sent by the network.

### 9.2.3.5.2 C-Plane Handling

Cell switch command is conveyed in a MAC CE, which contains the necessary information to perform the LTM cell switch.

The overall procedure for LTM is shown in FIG. 9.2.3.5.2-1 below. Subsequent LTM is done by repeating the early synchronization, LTM cell switch execution, and LTM cell switch completion steps without releasing other LTM candidate configurations after each LTM cell switch completion. The general procedure over the air interface is applicable to SCG LTM. Further details of SCG LTM can be found in TS 37.340 [21].

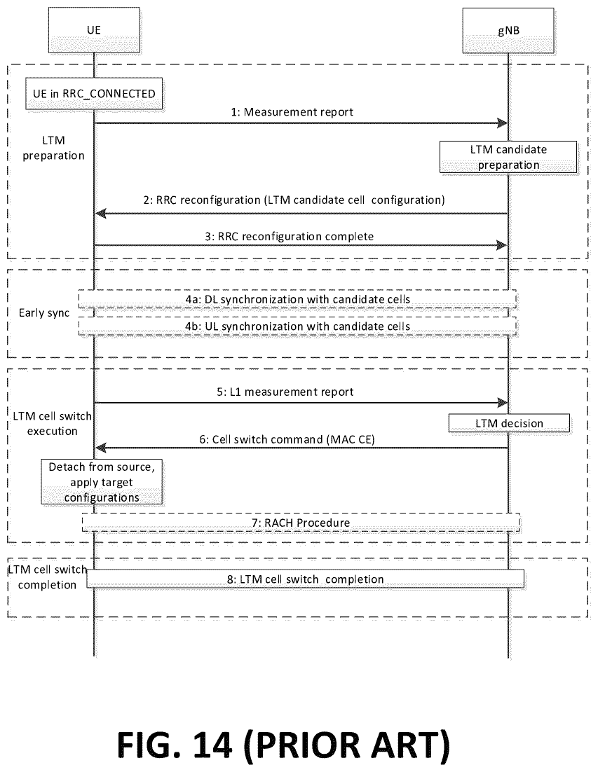

FIG. 14 is a reproduction of FIG. 9.2.3.5.2-1. Signaling procedure for LTM, from Draft 38.300 v 18.0.0.

The procedure for LTM is as follows:
1. The UE sends a MeasurementReport message to the gNB. The gNB decides to configure LTM and initiates LTM preparation.
2. The gNB transmits an RRCReconfiguration message to the UE including the LTM candidate configurations.
3. The UE stores the LTM candidate configurations and transmits an RRCReconfigurationComplete message to the gNB.
4a. The UE performs DL synchronization with the candidate cell(s) before receiving the cell switch command.
4b. When UE-based TA measurement is configured, UE acquires the TA value(s) of the candidate cell(s) by measurement. UE performs early TA acquisition with the candidate cell(s) as requested by the network before receiving the cell switch command as specified in clause 9.2.6. This is done via CFRA triggered by a PDCCH order from the source cell, following which the UE sends preamble towards the indicated candidate cell. In order to minimize the data interruption of the source cell due to CFRA towards the candidate cell(s), the UE doesn't receive random access response from the network for the purpose of TA value acquisition and the TA value of the candidate cell is indicated in the cell switch command. The UE doesn't maintain the TA timer for the candidate cell and relies on network implementation to guarantee the TA validity.
5. The UE performs L1 measurements on the configured candidate cell(s) and transmits L1 measurement reports to the gNB. L1 measurement should be performed as long as RRC reconfiguration (step 2) is applicable.
6. The gNB decides to execute cell switch to a target cell and transmits a MAC CE triggering cell switch by including the candidate configuration index of the target cell. The UE switches to the target cell and applies the configuration indicated by candidate configuration index.
7. The UE performs the random access procedure towards the target cell, if UE does not have valid TA of the target cell as specified in clause 6.1.3.xy of TS 38.321 [6].
8. The UE completes the LTM cell switch procedure by sending RRCReconfigurationComplete message to target cell. If the UE has performed a RA procedure in step 7 the UE considers that LTM cell switch execution is successfully completed when the random access procedure is successfully completed. For RACH-less LTM, the UE considers that LTM cell switch execution is successfully completed when the UE determines that the network has successfully received its first UL data.

The steps 4-8 can be performed multiple times for subsequent LTM using the LTM candidate configuration(s) provided in step 2.

The procedure over the air interface described in Figure x is applicable to both intra-gNB-DU LTM and inter-gNB-DU LTM. The overall LTM procedures over F1-C interface are captured in TS38.401 [4].

### 9.2.3.5.3 U-Plane Handling

After receiving an LTM cell switch command MAC CE, the UE performs MAC reset. Whether the UE performs RLC re-establishment and PDCP data recovery during cell switch is explicitly controlled by the network through RRC signalling.

In WID for mobility enhancement phase 4 ([6] RP-234036 New WID: NR mobility enhancements Phase 4), objective regarding measurement reporting for LTM is introduced:

### 3 Justification

Layer 2 mobility (LTM) was introduced in Rel-18 and can offer improvements in handover latency and interruption time compared to Layer 3 based mobility. However, LTM as introduced in Rel-18 also has a number of limitations compared to Layer 3 mobility. This Rel-19 work item aims to remove a number of these limitations.

LTM operation is only supported for mobility between cells of the same gNB (same CU). Depending on the deployment of the network this may significantly limit the opportunities to use LTM. By enabling LTM operation between cells of different gNBs (i.e. inter-CU) then the network will be able gain the benefits of LTM for a far greater number of handovers.

Layer 3 mobility uses layer 3 measurement reporting which supports UE evaluated events for triggering of measurement reports and reduces signalling overhead compared to periodic measurement reporting. Such event triggering is not supported by the L1 measurements that are used for LTM mobility.

L1 measurements for LTM procedures are limited to SSB measurements. Expanding L1 measurements to include CSI-RS can address this limitation and can be expected to enable greater throughput on the target cell immediately after cell switch.

Layer 3 mobility has evolved over several releases. Conditional handover (CHO) and other conditional mobility procedures (CPAC, SCPAC) were developed to achieve high robustness by enabling the procedure to be executed without necessitating a signalling exchange with source cell beforehand. LTM as introduced in Rel-18 offers short interruption time but not with the same level of robustness as the conditional L3 mobility procedures. In Rel-19, enhancements should be specified so that the system can benefit from both the high robustness and short interruption.

### 4 Objective

### 4.1 Objective of SI or Core Part WI or Testing Part WI

. . .
Measurements related enhancements for purpose of supporting LTM: [RAN2, RAN1]
   Measurement related enhancements are applicable to Intra-CU MCG/SCG LTM and Inter-CU MCG/SCG LTM
   Specify necessary components to support event triggered L1 measurement reporting [RAN2, RAN1]
      RAN1 and RAN2 to progress independently on the event triggered measurements objectives of their respective MIMO and Mobility enhancement WIs. Review progress at RAN #105 to see if any modification of objectives is required to avoid/manage any overlap in the work
   Specify support for CSI-RS measurements for LTM procedures and enable CSI-RS based beam management, and/or other necessary physical layer operations on candidate cells before LTM [RAN1]

In New Radio (NR), a network could configure a User Equipment (UE) with beam reporting (e.g., periodic or semi-persistent beam reporting) or activate or trigger aperiodic beam reporting (e.g., Channel State Information (CSI) reporting) to acquire or obtain channel state information or channel quality or beam quality for data/control transmissions. However, with frequent reporting, the UE could experience huge transmission overhead. On the other hand, with sparse reporting, the network may not be able to obtain the latest beam information in time and the quality of communication between a network and the UE could be deteriorated. In Rel-19 Multiple Input, Multiple Output (MIMO) phase 5, UE initiated/event-driven beam management to reduce latency and/or overhead is discussed. The UE could initiate or trigger a beam report in response to some condition or event being met (e.g., quality of currently activated beam being lower than a threshold and/or quality of a candidate beam being higher than a threshold). In addition, in mobility enhancement phase 4, UE-initiated beam reporting is also introduced for candidate cells in order to perform faster Lower Layer (e.g., L1/L2) Triggered Mobility (LTM).

In the current NR, there are other beam management mechanisms and/or other reporting and/or other procedures regarding beam changes and/or beam reporting. For example, a UE could change its (activated) beam for a Cell in response to receiving an activation Transmission Configuration Indicator (TCI) state Medium Access Control (MAC) Control Element (CE) associated with or indicating the Cell (or the Cell's Bandwidth Part (BWP)). With the introduction of UE-initiated beam reporting, the UE could have simultaneous an ongoing beam reporting procedure and the other procedures. One issue could be that a network could receive outdated beam information or the UE could transmit unnecessary beam reporting information when the two procedures collide.

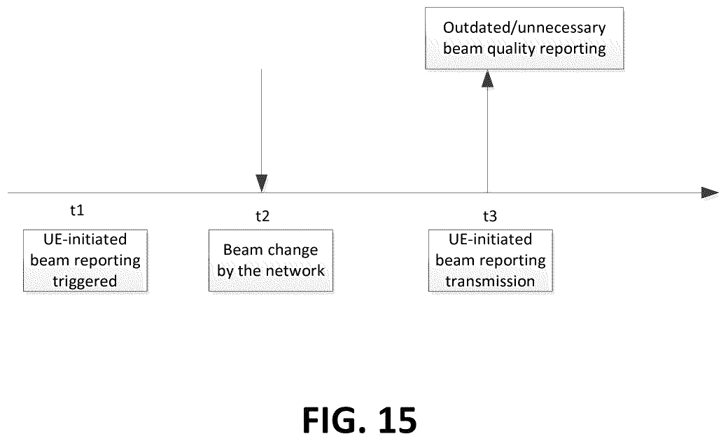

An example of the issue is shown in FIG. 15. At timing t1, the UE triggers a (UE-initiated) beam reporting, e.g., due to deterioration of beam quality of a BWP or a Cell. The UE could assemble a Transport Block (TB) or MAC Protocol Data Unit (PDU) for transmission of a report at timing t3. Additionally and/or alternatively, the UE could be (prepare to or configured with) a Physical Uplink Control Channel (PUCCH) resource for the transmission of the report at timing t3. Additionally and/or alternatively, the UE could trigger a Scheduling Request (SR) and/or initiate a random access procedure to the network for an Uplink (UL) grant for the report transmission. At timing t2, the network could provide a beam change (e.g., Transmission Configuration Indicator (TCI) state reconfiguration, activation/deactivation via MAC CE, etc.) for the BWP or for the Cell to the UE. At timing t3, the UE transmits beam reporting to the network. As the beam may be changed by the network in t2, the reporting in t3 may not be up to date or may cause confusion to the network.

In this present invention, methods for handling UE-initiated beam reporting overlapping with other UE procedures are discussed.

Collision between UE-initiated/event-driven beam reporting and (a) Beam Failure Recovery (BFR), (b) beam change, (c) serving cell change (Handover (HO) or LTM), (d) early Random Access Channel (RACH), (e) serving cell deactivation, and (f) MAC reset.
Same cell(s) or different cells.
   Handling differently depends on beam(s)/cell(s).
Parallel or cancel one of them.
   If UE-initiated/event-driven beam reporting is to be canceled, cancel/stop corresponding trigger/SR/RACH/timer.
Prioritization between UE-initiated/event-driven beam reporting MAC CE and BFR MAC CE (a).
   Duplicate information avoidance.
Estimation to trigger UE-initiated beam reporting may or may not be restarted.
   UE-initiated/event-driven beam reporting.
Support Truncated or not for UE-initiated/event-driven beam reporting.
   If yes, which to be reported first.
Whether to trigger SR for UE-initiated/event-driven beam reporting.
   Which SR configuration to use?
Format (MAC CE), e.g., one cell or multi-cells, serving cell only, or also neighbor/candidate cells.
   Discontinuous Reception (DRX) active time consideration in order to receive beam change MAC CE/indication.

One concept of the present invention is that a UE could determine whether to prioritize a UE-initiated beam reporting or (one of) a first one or more procedures. A UE could prioritize a UE-initiated beam reporting over (a part of) a first one or more procedures. Additionally and/or alternatively, the UE could de-prioritize a UE-initiated beam reporting from (a part of) the first one or more procedures. Additionally and/or alternatively, the UE could prioritize a part of the first one or more procedures and deprioritize another part of the first one or more procedures. The UE could determine whether to cancel a UE-initiated beam reporting based on at least (status of) a first one or more procedures of the UE. The UE could cancel a UE-initiated beam reporting when or if (at least) there is a (ongoing) first one or more procedures of the UE. The UE may not cancel the UE-initiated beam reporting when or if (at least) there is no (ongoing) first one or more procedures of the UE. Additionally and/or alternatively, the UE could cancel or stop (part of) the first one or more procedures when or if (at least) there is a (ongoing or triggered) UE-initiated beam reporting.

### Determine Based on Same/Different Cell

Additionally and/or alternatively, the UE could determine whether to cancel or de-prioritize a UE-initiated beam reporting associated with a Cell based on at least (a part of) the first one or more procedures associated with the Cell. The UE could cancel the UE-initiated beam reporting associated with the Cell due to/in response to a (part of) first one or more procedures associated with the Cell. The UE may not cancel the UE-initiated beam reporting associated with the Cell due to/in response to a (part of) first one or more procedures not associated with the Cell (e.g., (only) associated with other Cell(s)).

The first one or more procedures could contain a beam failure recovery procedure. The first one or more procedures could contain a triggered and not canceled BFR. The first one or more procedures could contain a random access procedure initiated for (Primary Cell (PCell) or SCell) beam failure recovery. The first one or more procedures could contain triggering a Scheduling Request (SR) for a (SCell) beam failure recovery. The first one or more procedures could contain a triggered and not canceled SR for beam failure recovery. The first one or more procedures could contain assembly and/or transmission of a BFR MAC CE.

Alternatively in certain embodiments, the first one or more procedures may not contain a beam failure recovery procedure. The first one or more procedures may not contain a triggered and not canceled BFR. The first one or more procedures may not contain a random access procedure initiated for (PCell or Secondary Cell (SCell)) beam failure recovery. The first one or more procedures may not contain triggering an SR for a (SCell) beam failure recovery. The first one or more procedures may not contain a triggered and not canceled SR for beam failure recovery. The first one or more procedures may not contain assembly and/or transmission of a BFR MAC CE.

The first one or more procedures could contain a beam change procedure. The beam change procedure could contain receiving a Radio Resource Control (RRC) reconfiguration indicating reconfiguration of one or more TCI states.

The beam change procedure could contain receiving a TCI state activation MAC CE (for Physical Downlink Shared Channel (PDSCH) and/or for Physical Downlink Control Channel (PDCCH) and/or for PUCCH and/or for Physical Uplink Shared Channel (PUSCH). The TCI state activation MAC CE could be for Downlink (DL) and/or UL beam change.

Alternatively in certain embodiments, the first one or more procedures may not contain a beam change procedure.

Additionally and/or alternatively, the first one or more procedures could contain initiating a random access procedure. The random access procedure could be initiated for reconfiguration with sync. The random access procedure could be initiated for L1/L2-triggered mobility (LTM) procedure.

Alternatively in certain embodiments, the first one or more procedures may not contain the random access procedure.

Additionally and/or alternatively, the random access procedure could be initiated for early UL synchronization for a candidate cell.

The first one or more procedures could contain a MAC reset. Alternatively in certain embodiments, the first one or more procedures may not contain a MAC reset.

The first one or more procedures could contain a Serving Cell deactivation. Alternatively in certain embodiments, the first one or more procedures may not contain a Serving Cell deactivation. The Serving Cell deactivation could contain receiving an SCell activation/deactivation MAC CE. Serving Cell deactivation could contain expiry of an SCell deactivation timer.

The first one or more procedures could contain a beam reporting initiated or requested by a network. The beam reporting could be a (periodic or aperiodic or semi-persistent) Channel State Information (CSI) reporting associated with a Cell.

The first one or more procedures could contain a Handover or reconfiguration with a sync procedure. The first one or more procedure could contain an LTM procedure.

The first one or more procedures could contain reconfiguration or release of candidate cell(s).

### Different Handling Based on Different Types of UE-Initiated Beam Reports: For LTM (for Candidate Cell) or for Serving Cell

Additionally and/or alternatively, the UE could determine whether to cancel or de-prioritize or stop a UE-initiated beam reporting associated with a Cell in response to (a part of) the first one or more procedures (associated with the Cell) based on at least the type of the Cell or based on at least a type or purpose of the UE-initiated beam reporting.

For example, the UE could cancel or de-prioritize or stop a UE-initiated beam reporting associated with a Serving Cell in response to the first one or more procedures associated with the Serving Cell. The UE may not (be allowed to) cancel or de-prioritize or stop a UE-initiated beam reporting associated with a candidate Cell (or LTM) in response to the first one or more procedures (associated with the candidate Cell) (e.g., in response to a reconfiguration with a sync procedure or in response to an LTM procedure).

For example, the UE could (re) start or reset or stop a timer or a counter associated with a UE-initiated beam reporting associated with a Serving Cell in response to the first one or more procedures associated with the Serving Cell. The UE may not (be allowed to) (re) start or reset or stop a timer or a counter associated with a UE-initiated beam reporting associated with a candidate Cell (or LTM) in response to the first one or more procedures (associated with the candidate Cell) (e.g., in response to a reconfiguration with a sync procedure or in response to an LTM procedure).

Additionally and/or alternatively, the UE could cancel or de-prioritize or stop a UE-initiated beam reporting associated with a candidate Cell in response to the first one or more procedures (associated with the candidate Cell) (e.g., in response to a reconfiguration with a sync procedure or in response to an LTM procedure). The UE may not cancel or de-prioritize or stop a UE-initiated beam reporting associated with a Serving Cell in response to the first one or more procedures associated with the Serving Cell.

Additionally and/or alternatively, the UE could (re) start or reset or stop a timer or a counter associated with a UE-initiated beam reporting associated with a candidate Cell in response to the first one or more procedures (associated with the candidate Cell) (e.g., in response to a reconfiguration with a sync procedure or in response to an LTM procedure). The UE may not (re) start or reset or stop a timer or a counter associated with a UE-initiated beam reporting associated with a Serving Cell in response to the first one or more procedures associated with the Serving Cell.

Collision with the First Procedure(s) when the Beam Reporting is Ongoing

For example, the UE could cancel or stop a (triggered or ongoing) UE-initiated beam reporting in response to triggering of a BFR. The UE could cancel or stop a (triggered or ongoing) UE-initiated beam reporting of a first Serving Cell in response to triggering of a BFR of the first Serving Cell. The UE may not cancel or stop a UE-initiated beam reporting of a first Serving Cell in response to triggering of a BFR of a second Serving Cell.

For another example, the UE may not trigger a BFR for a Serving Cell when there is a (triggered or ongoing) UE-initiated beam reporting associated with at least the Serving Cell.

For another example, the UE could (re) start or reset or stop a timer or a counter associated with a UE-initiated beam reporting of (the BWP of) the Cell in response to triggering of a BFR of (the BWP of) the first Serving Cell.

For another example, the UE could (re) start or reset or stop the timer or the counter associated with a UE-initiated beam reporting of (the BWP of) the Cell in response to (successful) completion of a beam failure recovery procedure associated with a triggered BFR of (the BWP of) the first Serving Cell.

For another example, the UE could cancel or stop a (triggered or ongoing) UE-initiated beam reporting in response to a beam change procedure. The UE could cancel or stop a (triggered or ongoing) UE-initiated beam reporting of (a BWP of) a first Serving Cell in response to a beam change procedure of (the BWP of) the first Serving Cell. The UE may not cancel or stop a UE-initiated beam reporting of a first Serving Cell in response to a beam change procedure of a second Serving Cell. The UE may not cancel or stop a UE-initiated beam reporting of a first BWP of the first Serving Cell in response to a beam change procedure of a second BWP of the first Serving Cell.

For another example, the UE could (re) start or reset or stop a timer or a counter associated with UE-initiated beam reporting of (the BWP of) the first Serving Cell in response to a beam change procedure of (the BWP of) the first Serving Cell. The timer or the counter could be used or configured to trigger or prohibit the UE-initiated beam reporting of the Cell.

For another example, the UE may not perform a beam change procedure for a (BWP of a) Serving Cell when there is a (triggered or ongoing) UE-initiated beam reporting associated with at least (the BWP of) the Serving Cell.

For another example, the UE could cancel or stop a (triggered or ongoing) UE-initiated beam reporting in response to (initiation of) a random access procedure. The UE could cancel or stop a (triggered or ongoing) UE-initiated beam reporting of a first Serving Cell (or a first candidate cell) in response to (initiation of) a random access procedure associated with the first Serving Cell (or the first candidate cell). The UE may not cancel or stop a UE-initiated beam reporting of a first Serving Cell (of a first candidate cell) in response to (initiation of) a random access procedure not associated with the first Serving Cell (of a second candidate cell).

For another example, the UE may not initiate a random access procedure (for early UL synchronization) for a Serving Cell (or a candidate cell) when or if (at least) there is a (triggered or ongoing) UE-initiated beam reporting associated with at least the Serving Cell (or the candidate cell).

For another example, the UE could cancel or stop a (triggered or ongoing) UE-initiated beam reporting in response to (initiation of) a MAC reset. The UE could cancel or stop a (triggered or ongoing) UE-initiated beam reporting of a first Serving Cell in response to a MAC reset associated with (a MAC entity of) the first Serving Cell. The UE may not cancel or stop a UE-initiated beam reporting of a first Serving Cell in response to a MAC reset not associated with the first Serving Cell.

For another example, the UE could (re) start or reset or stop a timer or a counter associated with a UE-initiated beam reporting of (the BWP of) the Cell in response to a MAC reset associated with the Cell.

For another example, the UE may not perform a MAC reset associated with a Serving Cell when there is a (triggered or ongoing) UE-initiated beam reporting associated with at least the Serving Cell.

For another example, the UE could cancel or stop a (triggered or ongoing) UE-initiated beam reporting in response to (triggering of) a SCell deactivation. The UE could cancel or stop a (triggered or ongoing) UE-initiated beam reporting of a first Serving Cell in response to deactivation the first Serving Cell (or in response to receiving a deactivation MAC CE for deactivating the first Serving Cell, or in response to expiry/expiration of a SCell deactivation timer of the first Serving Cell). The UE may not cancel or stop a UE-initiated beam reporting of a first Serving Cell in response to deactivation of a second Serving Cell.

For another example, the UE could (re) start or reset or stop a timer or a counter associated with a UE-initiated beam reporting of (the BWP of) the Cell in response to (triggering of) a deactivation of the Cell.

For another example, the UE could (re) start or reset or stop a timer or a counter associated with a UE-initiated beam reporting of (the BWP of) the Cell in response to (triggering of) an activation of the Cell.

For another example, the UE could (re) start or reset or stop the timer or the counter associated with a UE-initiated beam reporting of (the BWP of) the Cell in response to (successful) completion of a deactivation of the Cell.

For another example, the UE may not perform deactivation of a Serving Cell when there is a (triggered or ongoing) UE-initiated beam reporting associated with at least the Serving Cell.

For another example, the UE could cancel or stop a (triggered or ongoing) UE-initiated beam reporting of a first Serving Cell in response to receiving an aperiodic CSI report request associated with the first Serving Cell from a network. Alternatively in certain embodiments, the UE may not cancel or stop a (triggered or ongoing) UE-initiated beam reporting of a first Serving Cell when receiving an aperiodic CSI report request associated with the first Serving Cell from a network.

For another example, the UE could cancel or stop a (triggered or ongoing) UE-initiated beam reporting of a first Serving Cell in response to initiation of a reconfiguration with sync procedure, or in response to receiving a reconfiguration with a sync message from a network. Alternatively in certain embodiments, the UE may not cancel or stop a (triggered or ongoing) UE-initiated beam reporting of a first Serving Cell in response to initiation of a reconfiguration with a sync procedure, or in response to receiving a reconfiguration with a sync message from a network (that is not associated with the first Serving Cell).

For another example, the UE could cancel or stop a (triggered or ongoing) UE-initiated beam reporting of a first Serving Cell in response to initiation of an LTM procedure, or in response to receiving an LTM cell switch command MAC CE from a network. Alternatively in certain embodiments, the UE may not cancel or stop a (triggered or ongoing) UE-initiated beam reporting of a first Serving Cell in response to initiation of an LTM procedure, or in response to receiving an LTM cell switch command MAC CE from a network (that is not associated with the first Serving Cell).

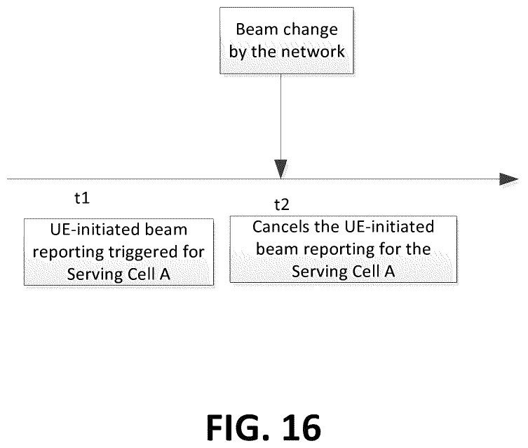

An example is shown in FIG. 16. At timing t1, the UE triggers a UE-initiated beam reporting for a Serving Cell A (e.g., due to a current beam quality lower than a threshold). At timing t2, the UE receives a beam change indication associated with the Serving Cell A from a network (e.g., a TCI state activation/deactivation MAC CE or RRC reconfiguration of TCI states). In response to the beam change indication, the UE cancels or stops the triggered UE-initiated beam reporting.

### Does not Trigger Report Based on the First Procedure is Ongoing

Additionally and/or alternatively, the UE could determine whether to trigger or initiate or perform the UE-initiated beam reporting based on at least whether there is an ongoing first one or more procedures. The UE may not trigger or initiate or perform the UE-initiated beam reporting for a Serving Cell if or when (at least) there is an ongoing first one or more procedures associated with the Serving Cell.

For example, the UE may not (be allowed to) trigger or initiate or perform a UE-initiated beam reporting when or if (at least) there is a triggered (and not canceled) BFR. The UE may not (be allowed to) trigger a UE-initiated beam reporting of a Serving Cell when or if (at least) there is a triggered (and not canceled) BFR of the Serving Cell. The UE could trigger a UE-initiated beam reporting of a first Serving Cell if or when (at least) there is no triggered BFR of the first Serving Cell.

For another example, the UE may not trigger or initiate or perform a UE-initiated beam reporting for a Cell when or if (at least) there is an ongoing beam failure recovery procedure associated with the Cell. For example, the UE may not trigger or initiate or perform a UE-initiated beam reporting when ra-responswindow and/or a contention resolution timer is running. The UE could trigger a UE-initiated beam reporting of a first Serving Cell if or when (at least) there is no ongoing beam failure recovery procedure of the first Serving Cell. The ongoing beam failure recovery procedure could include a random access procedure (initiated for beam failure recovery). The ongoing beam failure recovery procedure could include a triggered and not canceled SR associated with beam failure recovery (e.g., SR triggered for SCell BFR).

Additionally and/or alternatively, the UE may not trigger or initiate or perform a UE-initiated beam reporting for a Cell when or if (at least) there is an ongoing random access procedure associated with the Cell. Alternatively in certain embodiments, the UE could trigger or initiate or perform a UE-initiated beam reporting for a Cell when or if (at least) an ongoing random access procedure associated with the Cell is not initiated for beam failure recovery.

Additionally and/or alternatively, the UE may not trigger or initiate or perform a UE-initiated beam reporting for a Cell when or if (at least) there is an ongoing beam change procedure (associated with the Cell). Alternatively in certain embodiments, the UE could trigger or initiate or perform a UE-initiated beam reporting for a Cell when or if (at least) an ongoing beam change procedure is not associated with the Cell.

Additionally and/or alternatively, the UE may not trigger or initiate or perform a UE-initiated beam reporting for a Cell when or if (at least) there is an ongoing MAC reset procedure (associated with the Cell). Alternatively in certain embodiments, the UE could trigger or initiate or perform a UE-initiated beam reporting for a Cell when or if (at least) an ongoing MAC reset is not associated with the Cell.

Additionally and/or alternatively, the UE may not trigger or initiate or perform a UE-initiated beam reporting for a Cell when or if (at least) there is an ongoing Serving Cell deactivation procedure (associated with the Cell). Alternatively in certain embodiments, the UE could trigger or initiate or perform a UE-initiated beam reporting for a Cell when or if (at least) an ongoing Serving Cell deactivation procedure is not associated with the Cell.

Additionally and/or alternatively, the UE may not trigger or initiate or perform a UE-initiated beam reporting for a Cell when or if (at least) there is an ongoing reconfiguration with a sync procedure (associated with the Cell). Alternatively in certain embodiments, the UE could trigger or initiate or perform a UE-initiated beam reporting for a Cell when or if (at least) an ongoing reconfiguration with a sync procedure is not associated with the Cell (e.g., associated with another Cell group from the Cell).

For another example, the UE may not trigger a UE-initiated beam reporting of a first Serving Cell in response to an ongoing LTM procedure, or in response to receiving an LTM cell switch command MAC CE from a network. Alternatively in certain embodiments, the UE may not trigger a UE-initiated beam reporting of a first Serving Cell in response to an ongoing LTM procedure, or in response to receiving an LTM cell switch command MAC CE from a network (that is not associated with the first Serving Cell).

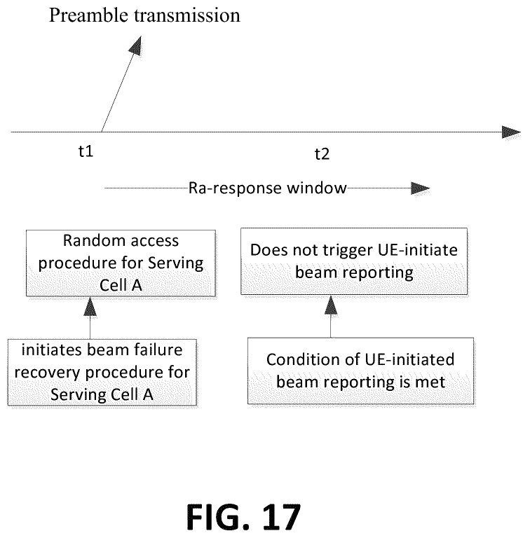

An example is shown in FIG. 17. At timing t1, the UE initiates a beam failure recovery procedure for Serving Cell A (e.g., a SpCell). The beam failure recovery procedure could contain a random access procedure for the Serving Cell A. The UE performs random access preamble transmission to the network in the random access procedure. The UE starts a window/timer (e.g., random access response window) in response to transmission of the preamble. During the window, when the timer is running, a condition of UE-initiated beam reporting (associated with the Serving Cell A) was met at timing t2 (e.g., quality of a current activated beam is lower than a threshold and/or a candidate beam quality is higher than a threshold). The UE may not initiate or trigger a UE-initiate beam reporting due to the window/timer is running and/or due to there is an ongoing random access procedure (for the Serving Cell A beam failure recovery).

### In Parallel

Additionally and/or alternatively, the UE could perform the UE-initiated beam reporting for a Cell when there is a part of the first one or more procedure ongoing. For example, the UE may not cancel or stop the UE-imitated beam reporting associated with a Cell if or when (at least) receiving a deactivation indication of the Cell.

### Different Handling Based on Different Types of UE-Initiated Beam Report: For LTM (for Candidate Cell) or for Serving Cell

Additionally and/or alternatively, when or if (at least) there is an ongoing first one or more procedures, the UE could determine whether to trigger or initiate or perform the UE-initiated beam reporting based on at least a type or purpose of the UE-initiated beam reporting. For example, the UE could initiate or perform UE-initiated beam reporting for LTM or for candidate cell when or if (at least) (one of) the first one or more procedures is ongoing. For another example, the UE may not perform UE-initiated beam reporting for a Serving Cell(s) when or if (at least) (one of) the first one or more procedures is ongoing.

For example, when or if (at least) there is an ongoing first one or more procedures (e.g., BFR, beam change procedure, MAC reset or Handover or an LTM procedure) the UE could trigger or initiate or perform a UE-initiated beam reporting for an L1 measurement report for LTM or for a candidate cell. When or if (at least) there is an ongoing first one or more procedures (e.g., BFR, beam change procedure, MAC reset or Handover or an LTM procedure) the UE may not trigger or initiate or perform a UE-initiated beam reporting for a Serving Cell.

Alternatively in certain embodiments, when or if (at least) there is an ongoing first one or more procedures (e.g., BFR, beam change procedure, MAC reset or Handover or an LTM procedure) the UE may not trigger or initiate or perform a UE-initiated beam reporting for an L1 measurement report for LTM or for a candidate cell. When or if (at least) there is an ongoing first one or more procedures (e.g., BFR, beam change procedure, MAC reset or Handover or an LTM procedure) the UE could trigger or initiate or perform a UE-initiated beam reporting for a Serving Cell.

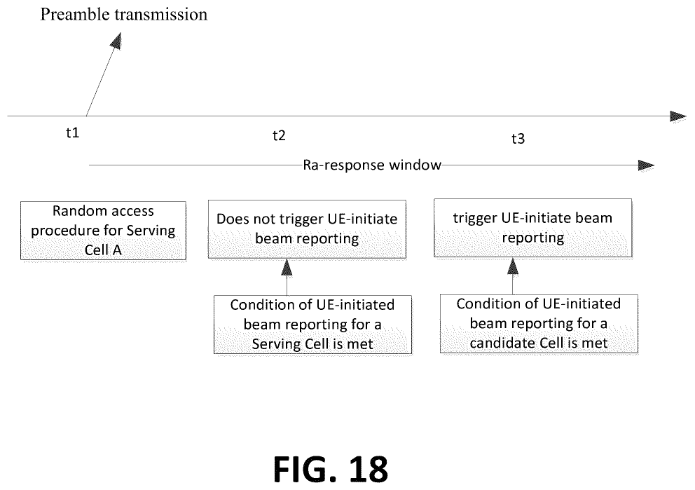

An example is shown in FIG. 18. A UE initiates or performs a random access procedure (e.g., Handover, reconfiguration with sync, or LTM) at timing t1. The UE performs preamble transmission and starts a random access response window. When the window is running at timing t2, a condition for a UE-initiated beam reporting for a Serving Cell is met. The UE does not trigger the UE-initiated beam reporting. At timing t3, a condition for UE-initiated beam reporting for a candidate cell is met, the UE could trigger the UE-initiated beam reporting for the candidate cell when the window is running.

### Prioritization Between Different Types of UE-Initiated Beam Reporting

Additionally and/or alternatively, the UE could determine whether to prioritize a first UE-initiated beam reporting or a second UE-initiated beam reporting based on at least types of the first and the second UE-initiated beam reporting.

A type of a UE-initiated beam reporting could be a reporting for a candidate cell or LTM. A type of a UE-initiated beam reporting could be a reporting for a Serving Cell.

For example, the UE could prioritize a first UE-initiated beam reporting associated with or in response to a candidate cell (or LTM) over a second UE-initiated beam reporting associated with a Serving Cell.

Alternatively in certain embodiments, the UE could prioritize a first UE-initiated beam reporting associated with or in response to a Serving Cell over a second UE-initiated beam reporting associated with candidate cell (or LTM).

Additionally and/or alternatively, the UE could be configured with a priority associated with (prioritization of) UE-initiated beam reporting. For example, a network could configure the UE to prioritize UE-initiated beam reporting for a Serving Cell (over candidate cell), or the network could configure the UE to prioritize UE-initiated beam reporting for a candidate Cell (over Serving cell). Alternatively in certain embodiments, each of the measurement objects (e.g., Serving Cell, candidate cell) could be configured with priority for UE-initiated beam reporting.

### Beam Reporting Format

Additionally and/or alternatively, the UE could transmit a UE-initiated beam report in the UE-initiated beam reporting procedure. The UE-initiated beam report could be a MAC CE and/or a RRC message and/or a physical layer signal or Uplink Control Information (UCI) via PUCCH or PUSCH.

The UE-initiated beam report could indicate whether a Cell is reported in the report and/or whether a beam of the Cell is reported in the report. Additionally and/or alternatively, (one format of) the UE-initiated beam report could indicate information of (only) one Cell. (One format of) the UE-initiated beam report may not be allowed to indicate information of more than one Cell. Additionally and/or alternatively, (one format of) the UE-initiated beam report could indicate information of more than one Cell. The more than one Cell could be associated with the same cell group. The more than one Cell may not be allowed to be associated with different cell groups. Alternatively in certain embodiments, the more than one Cell could be associated with different cell groups.

### Neighboring Cell

Additionally and/or alternatively, the UE-initiated beam report could indicate whether a candidate Cell or a neighboring Cell and/or whether a beam of the candidate Cell or a neighboring Cell is reported in the report. The report could indicate whether the Cell(s) reported is a Serving Cell, candidate cell, or a neighboring cell. The report could indicate a measurement object associated with the Cell(s).

Additionally and/or alternatively, the UE-initiated beam report could indicate one or more beams (e.g., via a TCI state Identity (ID) or via a bitmap mapping to TCI states or beams) for a Candidate Cell reported. The one or more beams could be (a part of) (configured or candidate) beams associated with the Candidate Cell with a quality higher than a threshold. The one or more beams could be n (configured or candidate) beams associated with the Candidate Cell with the top-n quality. The UE could select a (configured or fixed) number of beams (among one or more beams fulfilling the quality requirement, e.g., quality being higher than a threshold or with top-n quality) to report. The n could be configured or fixed, e.g., 1 or larger than 1.

Additionally and/or alternatively, the UE-initiated beam report could indicate one or more beams (e.g., via a TCI state ID or via a bitmap mapping to TCI states or beams) for a Serving Cell reported. The one or more beams could be (a part of) (configured or candidate) beams associated with the Serving Cell with a quality higher than a threshold. The one or more beams could be n (configured or candidate) beams associated with the Serving Cell with the top-n quality. The UE could select a (configured or fixed) number of beams (among one or more beams fulfilling the quality requirement, e.g., quality being higher than a threshold or with top-n quality) to report. The n could be configured or fixed, e.g., 1 or larger than 1.

Additionally and/or alternatively, the one or more beams could be the first n beams among (all) configured beams of the Serving Cell with highest quality.

Additionally and/or alternatively, the one or more beams could be the first n beams among (all) configured beams of the Candidate Cell with highest quality.

The quality could be associated with (L1 or L3) Reference Signal Received Power (RSRP), Received Signal Strength Indicator (RSSI), Reference Signal Received Quality (RSRQ), or Signal-To-Interference-Plus-Ratio (SINR).

The UE-initiated beam report could indicate quality (value(s)) of the one or more beams reported. Additionally and/or alternatively, the UE-initiated beam report may not report or indicate the quality (value(s)) of the one or more beams. Additionally and/or alternatively, the UE-initiated beam report may not indicate beams (e.g., index or ID) of the Serving Cell (e.g., only quality). Additionally and/or alternatively, the UE-initiated beam report may not indicate beams (e.g., index or ID) of the Candidate Cell (e.g., only quality).

The UE-initiated beam report could indicate a BWP of the Serving Cell reported. The BWP could be associated with triggered UE-initiated beam reporting. The BWP could contain a DL and/or UL BWP id.

### Truncated or not

Additionally and/or alternatively, when a UL grant is not enough to accommodate all information of all Cell(s) and/or all beams of the Cell(s) to be reported, a part of the information could be reported first (in a truncated UE-initiated beam report). The UE-initiated beam report could indicate whether information included in the UE-initiated beam report is complete or not. The UE-initiated beam report could indicate that information included in the UE-initiated beam report is not complete.

The UE could determine or select which Cells' information to report in a (truncated) UE-initiated beam report based on priority of the Cells. For example, the priority could be associated with Serving Cell index of a Serving Cell. The UE could include information of Serving Cells in ascending order or descending order of a Serving Cell index. A Special Cell (SpCell) (e.g., PCell or Primary and Secondary Cell (PSCell)) could have a higher priority than an SCell.

For another example, the priority could be associated with a type of the Cell. For example, the UE could prioritize reporting information of a Serving Cell over reporting information of a candidate cell or a neighboring cell. Alternatively in certain embodiments, the UE could prioritize reporting information of a candidate cell or a neighboring cell over reporting information of a Serving Cell.

The UE could determine or select which Cells' information to report in a (truncated) UE-initiated beam report based on quality associated with the Cell. Information of a first (candidate) cell could be prioritized (to be included in the (truncated) UE-initiated beam report) over information of a second (candidate) cell if (at least) quality associated with the first cell is higher than quality associated with the second cell (if or when a UL grant cannot accommodate all information associated with a triggered User Equipment Initiated (UEI) beam report of all Cells). Alternatively in certain embodiments, information of a first cell could be prioritized (to be included in the UE-initiated beam report) over information of a second cell if (at least) quality associated with the first cell is lower than quality associated with the second cell. The quality could be quality of the Cell. Alternatively in certain embodiments, the quality could be quality of a beam of the Cell. The beam could have the highest quality (among (all) beams of the Cell). The beam could be a candidate beam. The beam may not be an activated beam. Alternatively in certain embodiments, the beam could be an activated beam.

Additionally and/or alternatively, the UE could determine or select which information of a Cell to report based on quality associated with a beam (associated with the information). The UE could prioritize information of a first beam over information of a second beam (if or when a UL grant cannot accommodate all information associated with a triggered UEI beam report of all Cells) based on a quality of the first (candidate) beam being higher than a quality of the second beam.

Information of a Cell could include beams and/or a (beam) quality value associated with the Cell.

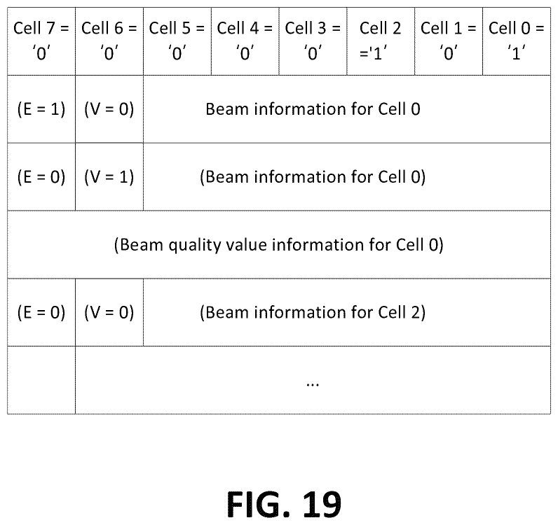

An example of a UE-initiated beam report is shown in FIG. 19. The report could include a bitmap (e.g., 8 bits) including whether information of a Cell is reported and/or whether the corresponding cell has triggered UE-initiated beam reporting. For example, the bit for Cell 0 equals ‘1’ indicates that Cell 0 experiences UE-initiated beam reporting/experiences a beam quality issue. The bit for Cell 1 equals ‘0’ indicates that Cell 1 is not associated with a triggered UE-initiated beam reporting. The report could contain beam information for Cell(s) reported. The information could be included in descending order of a Cell index or a Cell id (physical cell id). The report could include a field (e.g., E field) indicating whether the report includes further information of the Cell. For example, E field in the second octet set to ‘1’ indicates that the next octet is for information of a same Cell (e.g., another candidate beam). V field could indicate whether a quality value is reported. For example, V field set to ‘1’ indicates that a quality value for this beam is reported in the next octet.

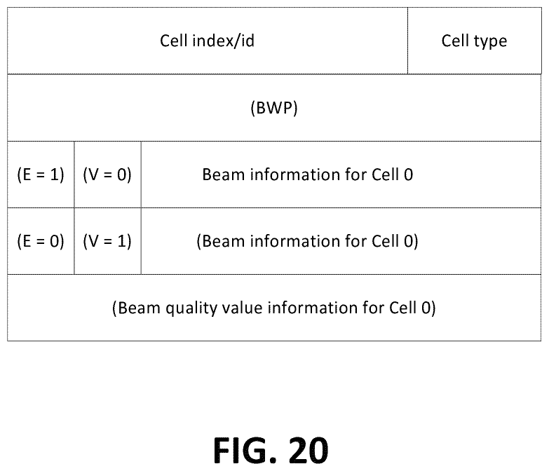

Another example is shown in FIG. 20. The UE-initiated beam report could include a Cell index (e.g., serving cell index or candidate cell index) or an id (e.g., a physical cell id). The report could include a cell type (e.g., Serving Cell, candidate cell, or neighboring cell). The network could determine how to interpret the Cell index/id field based on the Cell type. The report could include a BWP id associated with reported beam(s). The report could contain beam information associated with the one Cell (only). Alternatively in certain embodiments, the report could be extended to include beam information of multiple Cell(s).

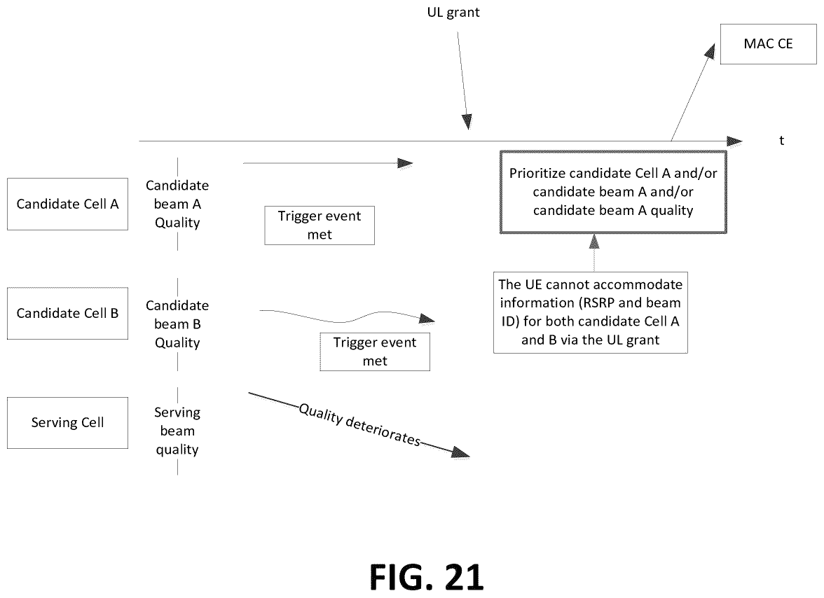

An example of determining information to report in a (truncated) UE-initiated beam report is shown in FIG. 21. The UE could be configured with a Serving Cell and two candidate Cells A and B. Quality of the Serving Cell (e.g., beam quality of currently activated beam) is degrading, and an event (e.g., serving beam quality<candidate beam quality+offset (for a period of time)) is met for both candidate Cell A and B. The UE could trigger UE-initiated beam reporting for the Candidate Cell A and B. The UE could receive a UL grant (or a configured UL grant is available) for transmitting a UEI beam report. The UL grant is not enough to accommodate all information including a beam value and beam ID (e.g., Synchronization Signal Block (SSB)-index) for candidate Cell A and B. The UE could determine prioritizing candidate Cell A information based on Cell quality of candidate Cell A being higher than candidate Cell B's quality. Alternatively and/or additionally, the UE could determine prioritizing candidate beam A over candidate beam B based on quality of beam A being higher than beam B.

### Prioritize UE-Initiated Beam Report Over BFR MAC CE

Additionally and/or alternatively, when assembling a MAC PDU, the UE could prioritize including a UE-initiated beam report (associated with a Cell) over including a BFR MAC CE (associated with the Cell) in the MAC PDU. Alternatively in certain embodiments, the UE could prioritize including a BFR MAC CE in the MAC PDU over a UE-initiated beam report. Additionally and/or alternatively, the UE may not include both a UE-initiated beam report and a BFR MAC CE (for a same Cell) in one MAC PDU.

Additionally and/or alternatively, when assembling a MAC PDU, the UE could prioritize including a UE-initiated beam report (associated with a Candidate Cell, e.g., for LTM) over including a BFR MAC CE (associated with Serving Cell(s)) in the MAC PDU. Alternatively in certain embodiments, when assembling a MAC PDU, the UE could prioritize including a BFR MAC CE (associated with Serving Cell(s)) over including a UE-initiated beam report (associated with a Candidate Cell, e.g., for LTM). Additionally and/or alternatively, the UE could prioritize including a BFR MAC CE (associated with Serving Cell(s)) in the MAC PDU over a UE-initiated beam report (associated with Serving Cell(s)).

The UE could trigger an SR for (requesting UL resources for) the UE-initiated beam report if or when (at least) there is no available UL resource for transmission of the report. Alternatively in certain embodiments, the UE may not trigger an SR for (requesting UL resources for) the UE-initiated beam report (even if or) when (at least) there is no available UL resource for transmission of the report. The SR could be associated with a same SR configuration as the SR for beam failure recovery (e.g., SCell BFR MAC CE). The SR may not be allowed to be associated with a different SR configuration as the SR for beam failure recovery (e.g., SCell BFR MAC CE). Additionally and/or alternatively, the SR configuration for the UE-initiated beam report could be different from the SR configuration for beam failure recovery (e.g., SCell BFR MAC CE). The SR configuration for the UE-initiated beam report could be configured by a network. Alternatively in certain embodiments, the SR configuration for the UE-initiated beam report could be associated with a fixed id.

Additionally and/or alternatively, the UE could indicate (buffer) size required for the UE-initiated beam report in a Buffer Status Report (BSR).

### DRX Active Time

Additionally and/or alternatively, the UE could stay in DRX active time or consider itself to be in DRX active while a UE-initiated beam report associated with a Serving Cell(s) is sent or transmitted (on PUSCH or PUCCH to a network) and until (any of) a condition is fulfilled. Additionally and/or alternatively, the UE could stay in DRX active time or consider itself to be in DRX active while a UE-initiated beam report associated with a Serving Cell(s) is triggered and until (any of) a condition is fulfilled. The condition could include one or multiple of the following:
A beam change procedure is initiated or completed; and/or
The beam change procedure could be receiving a TCI sate activation/deactivation MAC CE. The beam change procedure could be receiving a configuration reconfiguring TCI state for the Serving Cell(s). The beam change procedure could be for one, part, or all of the Serving Cell(s);
(All of) The Serving Cell(s) are deactivated; and/or
The Serving Cell(s) could be deactivated based on an SCell Activation/Deactivation MAC CE. The Serving Cell(s) could be deactivated based on expiry of sCellDeactivationTimer associated with the Serving Cell(s). The Serving Cell(s) could be deactivated based on Secondary Cell Group (SCG) deactivation;
Beam failure recovery procedure is initiated for (all of) the Serving Cell(s); and/or
The beam change procedure could be initiated when a BFR associated with the Serving Cell(s) is triggered;
A reconfiguration with sync or an LTM Cell Switch Command MAC CE to change (all or some of) the Serving Cell(s) is received.

The DRX active time of the UE could include the time between a timing when or after a UE-initiated beam report is transmitted for a Cell and a second timing when a signaling to change a beam (to be activated/deactivated) for the Cell is received.

Additionally and/or alternatively, the DRX active time of the UE could include the time between a timing when or after a UE-initiated beam reporting is triggered for a Cell and a second timing when a signaling to change a beam (to be activated/deactivated) for the Cell is received.

Additionally and/or alternatively, the UE could stay in DRX active time or consider itself to be in DRX active while a UE-initiated beam report associated with a Candidate Cell(s) is sent or transmitted (on PUSCH or PUCCH to a network) and until (any of) a condition is fulfilled. Additionally and/or alternatively, the UE could stay in DRX active time or consider itself to be in DRX active while a UE-initiated beam report associated with a Candidate Cell(s) is triggered and until (any of) a condition is fulfilled. The condition could include one or multiple of the following:
(All of) The Serving Cell(s) associated with (one, some or all of) the Candidate Cell(s) is deactivated; and/or
The Serving Cell(s) could be deactivated based on an SCell Activation/Deactivation MAC CE. The Serving Cell(s) could be deactivated based on expiry of sCellDeactivationTimer associated with the Serving Cell(s). The Serving Cell(s) could be deactivated based on SCG deactivation;
The Serving Cell(s) and the Candidate Cell(s) could be associated with the same cell group, e.g., a Master Cell Group (MCG) or SCG. For example, the Serving Cell(s) could belong to an SCG and the Candidate Cell(s) could be configured to replace the Serving Cell(s) belonging to the SCG;
A reconfiguration with sync or an LTM Cell Switch Command MAC CE to indicate (one of) the Candidate Cell(s) is received;
The reconfiguration with sync or the LTM Cell Switch Command MAC CE is to change SpCell (e.g., PCell or PSCell) to (one of) the Candidate Cell(s).

The DRX active time of the UE could include the time between a timing when or after a UE-initiated beam report is transmitted for a Cell and a second timing when a signaling to change a Serving Cell to the Cell is received.

Additionally and/or alternatively, the DRX active time of the UE could include the time between a timing when or after a UE-initiated beam reporting is triggered for a Cell and a second timing when a signaling to change a Serving Cell to the Cell is received.

Various examples and embodiments of the present invention are described below. For the methods, alternatives, concepts, examples, and embodiments detailed above and herein, the following aspects and embodiments are possible.

A UE-initiated beam reporting could be a CSI reporting. A UE-initiated beam reporting could be an event-driven beam reporting.

The UE-initiated beam reporting could be triggered or initiated in response to one or more condition(s) or event(s) being met.

The one or more condition(s) or event(s) could contain condition(s) associated with beam quality. For example, a condition could be quality of a (currently) activated beam being lower than or equal to a threshold. Additionally and/or alternatively, a condition could be quality of a candidate beam being higher than or equal to a threshold. The one or more conditions could be associated with or based on a measurement report triggering event. Additionally and/or alternatively, a condition or event could be quality of a (currently) activated beam being an offset lower than a quality of a candidate beam,

Additionally and/or alternatively, the condition could contain a candidate beam quality being higher than or equal to a (currently) activated beam quality (for a period of time).

The (currently) activated beam could be associated with a Serving Cell.

The candidate beam could be associated with a candidate Cell.

The UE-initiated beam reporting could contain determining whether to trigger the reporting based on at least a measured beam quality.

The beam quality could include RSRP, RSRQ, RSSI, and/or SINR associated with a beam.

A UE-initiated beam reporting could contain a trigger (of the reporting).

The UE-initiated beam reporting could contain triggering and/or transmitting an SR.

The UE-initiated beam reporting could contain initiating a random access procedure.

UE-initiated beam reporting could contain assembling a beam report (e.g., the beam report could be a MAC CE and/or RRC message and/or PUCCH signal).

The UE-initiated beam reporting could contain transmitting a beam report to a network.

The UE-initiated beam reporting could be initiated and/or configured for a Serving Cell. Additionally and/or alternatively, the UE-initiated beam reporting could be initiated and/or configured for a candidate cell or a non-Serving Cell.

The UE-initiated beam reporting could be an event-triggered L1 measurement reporting associated with LTM.

UE-initiated beam reporting could contain canceling a trigger of the beam reporting.

The UE could cancel the UE-initiated beam reporting in response to an initiation of the first one or more procedures.

The UE could cancel the UE-initiated beam reporting in response to an acknowledgement of the beam report from the network. The acknowledgement could be a UL grant for a new transmission associated with a Hybrid Automatic Repeat Request (HARQ) process used to transmit the beam report. The acknowledgement could be a beam activation/deactivation MAC CE. Additionally and/or alternatively, the UE could cancel the UE-initiated beam reporting (associated with a Cell) in response to transmitting the corresponding UE-initiated beam report (reporting information associated with the Cell).

When canceling or stopping a UE-initiated beam reporting, the UE could stop a corresponding procedure(s) contained in the UE-initiated beam reporting (mentioned above).

When canceling or stopping a UE-initiated beam reporting, the UE could stop or restart a timer for calculating or determining whether to trigger a UE-initiated beam reporting (e.g., a timeToTrigger-like timer).

The cancelation or stopping of the UE-initiated beam reporting could contain stopping the random access procedure. Additionally and/or alternatively, the cancelation or stopping of the UE-initiated beam reporting could contain stopping one or more timers associated with the UE-initiated beam reporting (e.g., timetotrigger for the beam reporting or timers associated with the random access procedures and/or associated with the SR).

The cancelation or stopping of the UE-initiated beam reporting of a Cell could contain not including or reporting (beam) information associated with the Cell in a UE-initiated beam report.

The cancellation or stopping of the UE-initiated beam reporting of a Cell could contain (re) starting or resetting or stopping a timer or a counter associated with UE-initiated beam reporting of the Cell.

The timer or the counter could be used or configured to trigger or prohibit the UE-initiated beam reporting of the Cell.

The UE could be configured with measurement object(s) associated with the UE-initiated beam reporting.

A measurement object could contain a Serving Cell and/or a non-serving cell.

A measurement object could be associated with SSB and/or Channel State Information Reference Signal (CSI-RS) associated with the Serving Cell and/or the non-Serving Cell.

To prioritize a UE-initiated beam reporting over a first one or more procedures, the UE stops the procedure and continues the reporting.

To prioritize a first one or more procedures over a UE-initiated beam reporting, the UE stops/cancels the reporting and continues the first one or more procedures.

To prioritize a first UE-initiated beam reporting over a second UE-initiated beam reporting, the UE could cancel a trigger associated with the second UE-initiated beam reporting (when or if (at least) the UE triggers the first UE-initiated beam reporting), and/or the UE does not trigger the second UE-initiated beam reporting.

To prioritize a first UE-initiated beam reporting over a second UE-initiated beam reporting, the UE could include (a UE-initiated beam report associated with) the first UE-initiated beam reporting in a MAC PDU (when assembling the MAC PDU) before including (a UE-initiated beam report associated with) the second UE-initiated beam reporting. To prioritize a first UE-initiated beam reporting over a second UE-initiated beam reporting, the UE could include (a UE-initiated beam report associated with) the first UE-initiated beam reporting and may not include (a UE-initiated beam report associated with) the second UE-initiated beam reporting in the MAC PDU if or when (at least) the MAC PDU cannot accommodate both (reports for) the first and the second UE-initiated beam reporting.

The prioritization is to decide the order or priority of different content(s) (e.g., different MAC CE(s)) to be included in a MAC PDU. Content with lower priority may not be included in the MAC PDU if (at least) the remaining space of the MAC PDU is insufficient.

The reporting and the first one or more procedures could be overlapped in time domain.

The reporting and the procedure could be associated with a same serving cell and/or a same MAC entity and/or a same Cell group (e.g., MCG or SCG).

The beams could be replaced by or referred to SSB (associated with SSB index or SSB resource indicator, Synchronization Signal (SS)/Physical Broadcast Channel (PBCH) Resource Block Indicator (SSBRI)), CSI-RS, and/or (DL or UL) TCI states.

The Cell could be a Serving Cell, candidate cell, and/or a neighboring cell.

A candidate cell could be an LTM candidate Cell. A neighboring cell could be a cell associated with a measurement object. The candidate cell and the neighboring cell are not Serving Cells.

All concepts, example, and embodiments above and herein could be combined into new concepts.

Various examples and embodiments of the present invention are described below. For the methods, alternatives, concepts, examples, and embodiments detailed above and herein, the following aspects and embodiments are possible.

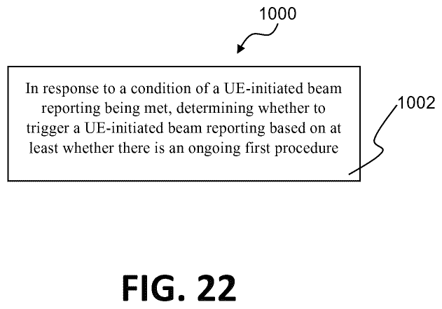

Referring to FIG. 22, with this and other concepts, systems, and methods of the present invention, a method 1000 for a UE in a wireless communication system comprises in response to a condition of a UE-initiated beam reporting being met, determining whether to trigger a UE-initiated beam reporting based on at least whether there is an ongoing first procedure (step 1002).

In various embodiments, the UE triggers the UE-initiated beam reporting in response to the condition of a UE-initiated beam reporting being met if or when there is no ongoing first procedure.

In various embodiments, the UE does not trigger the UE-initiated beam reporting in response to the condition of a UE-initiated beam reporting being met if or when there at least one ongoing first procedure.

In various embodiments, the first procedure is a random access procedure.

In various embodiments, the random access procedure is initiated in response to beam failure recovery.

In various embodiments, the first procedure is a reconfiguration with a sync procedure.

In various embodiments, the UE-initiated beam reporting is associated with a Cell.

In various embodiments, the UE triggers the UE-initiated beam reporting associated with a Serving Cell in response to the condition of a UE-initiated beam reporting being met if or when there is no ongoing first procedure associated with the Serving Cell.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) in response to a condition of a UE-initiated beam reporting being met, determine whether to trigger a UE-initiated beam reporting based on at least whether there is an ongoing first procedure. Moreover, the CPU 308 can execute the program code 312 to perform all of the described actions, steps, and methods described above, below, or otherwise herein.

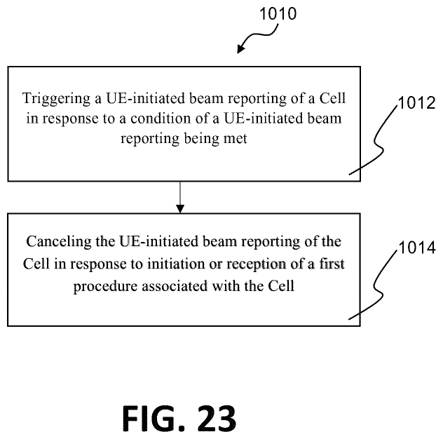

Referring to FIG. 23, with this and other concepts, systems, and methods of the present invention, a method 1010 for a UE in a wireless communication system comprises triggering a UE-initiated beam reporting of a Cell in response to a condition of a UE-initiated beam reporting being met (step 1012), and canceling the UE-initiated beam reporting of the Cell in response to initiation or reception of a first procedure associated with the Cell (step 1014).

In various embodiments, the first procedure includes a random access procedure.

In various embodiments, the random access procedure is initiated in response to beam failure recovery for the Cell.

In various embodiments, the first procedure includes a reconfiguration with a sync procedure.

In various embodiments, the first procedure includes receiving a TCI state or beam activation/deactivation MAC CE indicating TCI state/beam activation/deactivation associated with the Cell.

In various embodiments, the first procedure includes Cell deactivation including at least the Cell.

In various embodiments, the first procedure includes a MAC reset.

In various embodiments, the first procedure includes triggering a (SCell) BFR of the Cell.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) trigger a UE-initiated beam reporting of a Cell in response to a condition of a UE-initiated beam reporting being met; and (ii) cancel the UE-initiated beam reporting of the Cell in response to initiation or reception of a first procedure associated with the Cell. Moreover, the CPU 308 can execute the program code 312 to perform all of the described actions, steps, and methods described above, below, or otherwise herein.

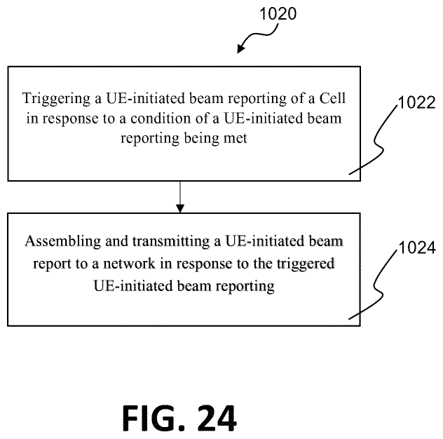

Referring to FIG. 24, with this and other concepts, systems, and methods of the present invention, a method 1020 for a UE in a wireless communication system comprises triggering a UE-initiated beam reporting of a Cell in response to a condition of a UE-initiated beam reporting being met (step 1022), and assembling and transmitting a UE-initiated beam report to a network in response to the triggered UE-initiated beam reporting (step 1024).

In various embodiments, the UE-initiated beam report indicates a Cell index associated with the Cell.

In various embodiments, the UE-initiated beam report indicates the Cell is reported or has triggered UE-initiated beam reporting.

In various embodiments, the UE-initiated beam report indicates beam information of the Cell.

In various embodiments, the beam information includes a beam index or TCI state id associated with the Cell.

In various embodiments, the UE-initiated beam report includes beam information of the Cell based on a Cell index in ascending order or descending order.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) trigger a UE-initiated beam reporting of a Cell in response to a condition of a UE-initiated beam reporting being met; and (ii) assemble and transmit a UE-initiated beam report to a network in response to the triggered UE-initiated beam reporting. Moreover, the CPU 308 can execute the program code 312 to perform all of the described actions, steps, and methods described above, below, or otherwise herein.

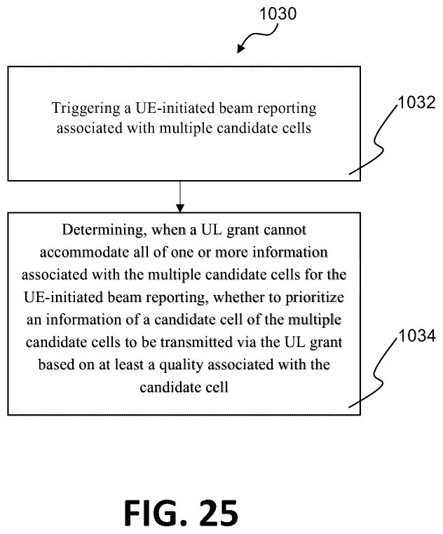

Referring to FIG. 25, with this and other concepts, systems, and methods of the present invention, a method 1030 for a UE in a wireless communication system comprises triggering a UE-initiated beam reporting associated with multiple candidate cells (step 1032), and determining, when a UL grant cannot accommodate all of one or more information associated with the multiple candidate cells for the UE-initiated beam reporting, whether to prioritize an information of a candidate cell of the multiple candidate cells to be transmitted via the UL grant based on at least a quality associated with the candidate cell (step 1034).

In various embodiments, the UE prioritizes a first information associated with a first candidate cell over a second information associated with a second candidate cell if or when quality associated with the first candidate cell is higher than quality associated with the second candidate cell.

In various embodiments, the method further comprises determining whether to prioritize information of a beam associated with the candidate cell based on quality of the beam.

In various embodiments, the UE prioritizes a first information of a first beam (associated with a first candidate cell) over a second information of a second beam (associated with the first candidate cell or a second candidate cell) if or when quality of the first beam is higher than quality of the second beam.

In various embodiments, the first beam and the second beam are associated with different candidate cells or a same candidate cell.

In various embodiments, the quality associated with the candidate cell is quality of a beam associated with the candidate cell.

In various embodiments, the beam is associated with a highest quality among one or more beams of the candidate cell.

In various embodiments, when the UL grant cannot accommodate all of the one or more information, the UE performs the UE-initiated beam reporting with a truncated UE-initiated beam report.

In various embodiments, the information indicates at least one of one or more beams, quality of the one or more beams, or a cell index.

In various embodiments, the UE performs the UE-initiated beam reporting via a MAC CE.

In various embodiments, the MAC CE indicates that information included in the MAC CE is not complete.

In various embodiments, the UE-initiated beam reporting is triggered in response to one or more conditions being met, wherein the one or more conditions contain at least one of: quality of a currently activated beam being lower than a threshold; and/or quality of a candidate beam being higher than a threshold.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) trigger a UE-initiated beam reporting associated with multiple candidate cells; and (ii) determine, when a UL grant cannot accommodate all of one or more information associated with the multiple candidate cells for the UE-initiated beam reporting, whether to prioritize an information of a candidate cell of the multiple candidate cells to be transmitted via the UL grant based on at least a quality associated with the candidate cell. Moreover, the CPU 308 can execute the program code 312 to perform all of the described actions, steps, and methods described above, below, or otherwise herein.

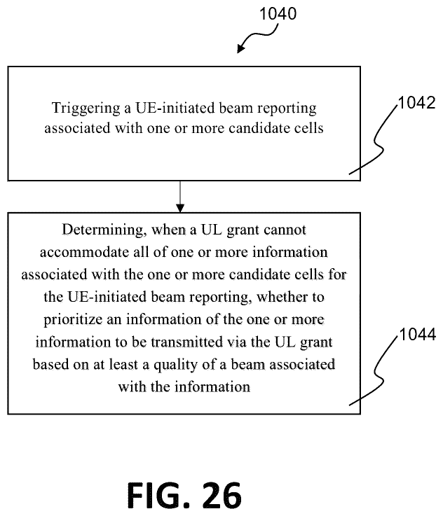

Referring to FIG. 26, with this and other concepts, systems, and methods of the present invention, a method 1040 for a UE in a wireless communication system comprises triggering a UE-initiated beam reporting associated with one or more candidate cells (step 1042), and determining, when a UL grant cannot accommodate all of one or more information associated with the one or more candidate cells for the UE-initiated beam reporting, whether to prioritize an information of the one or more information to be transmitted via the UL grant based on at least a quality of a beam associated with the information (step 1044).

In various embodiments, the UE prioritizes a first information of a first beam over a second information of a second beam if or when quality of the first beam is higher than quality of the second beam.

In various embodiments, the UE prioritizes a first information associated with a first candidate cell over a second information associated with a second candidate cell if or when quality associated with the first candidate cell is higher than quality associated with the second candidate cell.

In various embodiments, the quality associated with a candidate cell is quality of a beam associated with the candidate cell.

In various embodiments, the UL grant cannot accommodate all of the one or more information, the UE performs the UE-initiated beam reporting with a truncated UE-initiated beam report.

In various embodiments, the information indicates at least one of one or more beams, quality of the one or more beams, or a cell index.

In various embodiments, the UE performs the UE-initiated beam reporting via a MAC CE.

In various embodiments, the MAC CE indicates that information included in the MAC CE is not complete.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) trigger a UE-initiated beam reporting associated with one or more candidate cells; and (ii) determine, when a UL grant cannot accommodate all of one or more information associated with the one or more candidate cells for the UE-initiated beam reporting, whether to prioritize an information of the one or more information to be transmitted via the UL grant based on at least a quality of a beam associated with the information. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
triggering a UE-initiated beam reporting associated with multiple candidate cells; and
determining, when an Uplink (UL) grant cannot accommodate all of one or more information associated with the multiple candidate cells for the UE-initiated beam reporting, whether to prioritize an information of a candidate cell of the multiple candidate cells to be transmitted via the UL grant based on at least a quality associated with the candidate cell.

2. The method of claim 1, wherein the UE prioritizes a first information associated with a first candidate cell over a second information associated with a second candidate cell if or when quality associated with the first candidate cell is higher than quality associated with the second candidate cell.

3. The method of claim 1, further comprising determining whether to prioritize information of a beam associated with the candidate cell based on quality of the beam.

4. The method of claim 3, wherein the UE prioritizes a first information of a first beam over a second information of a second beam if or when quality of the first beam is higher than quality of the second beam.

5. The method of claim 4, wherein the first beam and the second beam are associated with different candidate cells or a same candidate cell.

6. The method of claim 1, wherein the quality associated with the candidate cell is quality of a beam associated with the candidate cell.

7. The method of claim 6, wherein the beam is associated with a highest quality among one or more beams of the candidate cell.

8. The method of claim 1, wherein when the UL grant cannot accommodate all of the one or more information, the UE performs the UE-initiated beam reporting with a truncated UE-initiated beam report.

9. The method of claim 1, wherein the information indicates at least one of one or more beams, quality of the one or more beams, or a cell index.

10. The method of claim 1, wherein the UE performs the UE-initiated beam reporting via a Medium Access Control (MAC) Control Element (CE).

11. The method of claim 10, wherein the MAC CE indicates that information included in the MAC CE is not complete.

12. The method of claim 1, wherein the UE-initiated beam reporting is triggered in response to one or more conditions being met, wherein the one or more conditions contain at least one of:
quality of a currently activated beam being lower than a threshold; and/or
quality of a candidate beam being higher than a threshold.

13. A method of a User Equipment (UE), comprising:
triggering a UE-initiated beam reporting associated with one or more candidate cells; and
determining, when an Uplink (UL) grant cannot accommodate all of one or more information associated with the one or more candidate cells for the UE-initiated beam reporting, whether to prioritize an information of the one or more information to be transmitted via the UL grant based on at least a quality of a beam associated with the information.

14. The method of claim 13, wherein the UE prioritizes a first information of a first beam over a second information of a second beam if or when quality of the first beam is higher than quality of the second beam.

15. The method of claim 13, wherein the UE prioritizes a first information associated with a first candidate cell over a second information associated with a second candidate cell if or when quality associated with the first candidate cell is higher than quality associated with the second candidate cell.

16. The method of claim 15, wherein the quality associated with a candidate cell is quality of a beam associated with the candidate cell.

17. The method of claim 13, wherein when the UL grant cannot accommodate all of the one or more information, the UE performs the UE-initiated beam reporting with a truncated UE-initiated beam report.

18. The method of claim 13, wherein the information indicates at least one of one or more beams, quality of the one or more beams, or a cell index.

19. The method of claim 13, wherein the UE performs the UE-initiated beam reporting via a Medium Access Control (MAC) Control Element (CE) and/or the MAC CE indicates that information included in the MAC CE is not complete.

20. A User Equipment (UE), comprising:
a memory; and
a processor operatively coupled with the memory, wherein the processor is configured to execute a program code to:
trigger a UE-initiated beam reporting associated with multiple candidate cells; and
determine, when an Uplink (UL) grant cannot accommodate all of one or more information associated with the multiple candidate cells for the UE-initiated beam reporting, whether to prioritize an information of a candidate cell of the multiple candidate cells to be transmitted via the UL grant based on at least a quality associated with the candidate cell.
